(19) United States
(12) Patent Application Publication
(10) Pub. No.: US 2025/0382951 A1
(43) Pub. Date: Dec. 18, 2025

(54) MAGNIFIED LINEAR POWER GENERATION SYSTEM

(71) Applicant: Propitious Technical Services LLC, Phoenix, AZ (US)

(72) Inventor: Jon Patrick Hurry, Phoenix, AZ (US)

(21) Appl. No.: 18/879,884

(22) PCT Filed: Jun. 30, 2023
(86) PCT No.: PCT/US2023/026666

§ 371 Date: Dec. 30, 2024

Related U.S. Application Data
(60) Provisional application No. 63/357,049, filed on Jun. 30, 2022.

(51) Int. Cl. F03G 7/08; B60H 1/00; B60L 1/00; B60P 3/20; B62D 33/04; F15B 15/14

(52) U.S. Cl. CPC F03G 7/081; B60H 1/00428; B60P 3/20; B62D 33/048; F15B 15/1428; B60L 1/003

(57) ABSTRACT

A magnified linear power generation system includes a vehicle with a tractor, or other tow vehicle, and a trailer, the trailer being separable from the tractor, the vehicle including at least one force receiving surface, the force receiving surface receiving input forces from the ground as the vehicle moves across the ground. A power generator is mounted to the trailer, the power generator including a stator and a mover. A mechanical magnification component is coupled between the power generator and the vehicle, the mechanical magnification component including a first hydraulic cylinder connected to the force receiving surface and a second hydraulic cylinder connected to the power generator, the first hydraulic cylinder having a first cylinder diameter, the second hydraulic cylinder having a second cylinder diameter smaller than the first cylinder diameter, wherein the first hydraulic cylinder is connected to the second hydraulic cylinder by a hydraulic line extending between the tractor and the trailer.

### BACKGROUND OF THE INVENTION

The present invention relates to a magnified linear power generation system.

The suspensions in motor vehicles absorb energy from the road or other surface when the vehicle encounters an obstacle or any other form of resistance to lessen or dampen additional motion on the car. With the increasing electrification of vehicles (e.g. cars, trucks, trailers, golf carts, bikes, motorcycles, tricycles, scooters, all-terrain vehicles, etc.), the absorbed (or wasted) mechanical energy can be captured and stored as electrical energy for use by the vehicle. This can save on energy costs and make the vehicle more efficient. Additionally, capturing the wasted energy can increase the range of an electric vehicle or reduce the size of the battery pack that is used in the vehicle.

Newton's third law states that for every action there is an equal and opposite reaction. For example, when a tire hits a bump it moves upward and the energy moving the tire upward is taken away from the vehicle's forward momentum. This energy is lost or neglected and thus results in inefficiencies because the energy is not being used for the vehicle's forward momentum. Current systems implement motors and batteries in a hybrid drivetrain for trailers but neglect the available energy from road vibration. Available road vibration energy can increase the efficiency of the vehicle system.

Power generating suspensions (PGS) can capture a portion of the lost kinetic energy and convert it to electrical energy that may be stored in a battery. PGS typically use linear generators to capture a portion of the kinetic energy lost with the compression and expansion of the vehicle suspension and convert it to electrical energy. That electrical energy can be used to drive an electric machine (e.g. a drive motor on a vehicle, a drive motor on a refrigerator, or any number of electric motors or other electronics). Many vehicles use alternators, or even larger generators in the case of a refrigerated semi-trailer, to generate the necessary energy to power the electric machines, which has associated costs.

A PGS system is known to be used to replace a vehicle strut. This PGS system is constrained to a vertical orientation. Additionally, a PGS used as a vehicle strut is limited to the available packaging space of the vehicle strut it is replacing.

Energy in a vehicle is dissipated from mechanical motion such as road irregularities, vehicle body roll, acceleration, and braking. Approximately 30% of the inefficiency of a vehicle is due to energy lost due to road surface quality. The wide variety of road surface quality creates different velocity and stroke conditions with every suspension. A traditional linear generator is designed to be run at a constant velocity and stroke distance.

Conventional systems only capture a portion of the available energy because some of the movements are too small to be picked up by the generators. The heavier the vehicle and the higher the irregularities on the road, the better total energy recovery.

### SUMMARY OF THE INVENTION

In one aspect, a magnified linear power generation system for use with a vehicle may include a linear power generator and a mechanical magnification component. The linear power generator may include a stator and a mover. The mechanical magnification component can be coupled to the mover at one end and a force receiving surface of the vehicle at another end. When the mechanical magnification component receives an input power from the force receiving surface, the mechanical magnification component may magnify the input velocity while decreasing the input force and output the magnified velocity to the mover. The mover can utilize the magnified velocity to move along the stator such that the linear power generator outputs electrical energy. The electrical energy may be stored or otherwise used by systems of the vehicle or its cargo.

In another aspect, the stator may include a plurality of electrical coils wound around a plurality of stator cups to form bobbin-wound coils. A suitable number of the stator cups can be stacked along a fixed stator shaft. The mover may include a plurality of magnets and a material between each of the plurality of magnets such that the magnets are separated from each other by a fixed distance. The mover can at least partially surround the stator. A casing may surround the mover and the stator and the casing may have a non-magnetic outer surface.

In still another aspect, the stator may include a plurality of electrical coils wound around a plurality of stator cups to form bobbin-wound coils. A suitable number of the stator cups can be stacked along a fixed stator shaft. The mover may include a plurality of magnets and a material between each of the plurality of magnets such that the magnets are separated from each other by a fixed distance. The stator may at least partially surround the mover. A housing may surround the mover and the stator and the casing may have a non-magnetic outer surface. A casing may surround the generator. A biasing component can be coupled to the mover at a distal end from the mechanical magnification component. The biasing component may include a compressible material which can apply a biasing force on the mover to position the mover at a neutral location with respect to the stator. The mechanical force applied to the mover can overcome the biasing force such that the mover moves within the stator thereby translating mechanical energy into electrical energy. The biasing component may reposition the mover to the neutral location.

In one aspect, the magnified linear generator may be incorporated in a semi-trailer.

In one aspect, the magnified linear generator may be used in micro-mobility applications such as in an electric scooter, an electric bike, a golf cart, and a low powered cycle (e.g. a moped).

In one aspect, the magnified linear generator may be incorporated into a shipping container. The shipping container may or may not be refrigerated.

In one embodiment, the magnified power generator may include a fluid magnification component, which may be a hydraulic magnification component. The magnification component may include a first hydraulic cylinder coupled to the force receiving surface and a second hydraulic cylinder connected to the mover, the first hydraulic cylinder having a first cylinder diameter, the second hydraulic cylinder having a second cylinder diameter smaller than the first cylinder diameter, wherein the first hydraulic cylinder is connected to the second hydraulic cylinder by a hydraulic line, wherein the hydraulic cylinders operate to magnify the input velocity. In one embodiment, the vehicle includes a semi-tractor, or other tow vehicle, and trailer, the first hydraulic cylinder mounted to the semi-tractor, the second hydraulic cylinder mounted to the trailer, and the hydraulic line extending between the semi-tractor and the trailer. The first hydraulic cylinder may be mounted to an axle of the tractor, or an axle of the trailer.

These and other objects, advantages, and features of the invention will be more fully understood and appreciated by reference to the description of the current embodiments and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and may be practiced or may be carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a side view magnified linear generator according to one aspect.

FIG. 2 is a side view of a magnified linear generator according to one aspect.

FIGS. 3A-3B are a cross-sectional view of the magnified linear generator of FIG. 2 along the line III-III with a mover of a linear generator in two positions.

FIG. 4 is a magnified linear generator according to one aspect.

FIG. 5 is an electrical circuit diagram of the AC-DC converter 500 according to one aspect.

FIG. 6 is a cross-sectional view of the generator of FIG. 4 along the line VI-VI.

FIG. 7 is an exemplary aspect of the winding configuration for the stator of FIG. 4.

FIG. 8 shows the overall interconnection of three of the phase groups as shown in FIG. 7.

FIG. 9 is a three-phase star of slots diagram for the interconnection of FIG. 8.

FIG. 10 is a stator assembly with stackable stator cups and windings according to one aspect.

FIG. 11 is a prior art graph of the available energy for a given level of road unevenness for vehicles of varying mass.

FIG. 12 is a set of simulation results showing the simulated amount of available energy for vehicles of varying mass for a range of road unevenness profiles.

FIGS. 13A-13B are a sample simulation result for a magnified linear generator according to one aspect.

FIG. 14 is a side view of a semi-truck with a trailer and a magnified linear generator according to one aspect.

FIG. 15 is a perspective view of a semi-trailer with a magnified linear generator installed according to one aspect.

FIG. 16 is a magnified linear generator installed in an electric scooter according to one aspect.

FIG. 17 is a magnified linear generator installed in an electric bicycle according to one aspect.

FIG. 18 is a magnified linear generator installed in a low powered cycle according to one aspect.

FIGS. 19A-19B are a perspective and a front view of two magnified linear generators installed on a shipping container according to one aspect.

FIG. 19C is a front view of one of the magnified linear generators of FIG. 19A.

FIG. 20A is a side view of a magnified power generator with an alternative magnification mechanism.

FIG. 20B is a side view of a portion of a magnified power generator with the alternative magnification mechanism.

FIG. 21A is a perspective view of a plurality of hollow conductors.

FIG. 21B is a perspective view of a hollow conductor system.

FIG. 21C is a front view of a hollow conductor system.

FIG. 21D is a front view of a hollow conductor system wherein the hollow conductor is bent.

### DETAILED DESCRIPTION OF THE CURRENT EMBODIMENT

In order to capture a larger amount of the available energy, a power generator must be capable of operating with a small amount of input energy. These smaller losses are generally neglected because the generators are designed to capture the larger energy sources.

A power generating suspension (PGS) system can harvest the power lost in a vehicle suspension to power electrical systems on a vehicle, vehicle cargo, vehicle accessory, or any other component that requires electrical power. In some aspects, a PGS can supplant an alternator, generator, or battery to power electrical systems. A PGS may use either a rotary or linear generator to produce electricity from the movement of the suspension. This application relates to PGS systems using a linear generator. Typical suspension travel is vertical in most modes of transportation and can be very small movements which are not easily captured by a rotary or linear generator in part due to the weight of the generator itself. This may make known linear or rotary generators too expensive to implement because the generator may not be capturing enough energy and thereby saving the operator enough money to offset the cost of the generator itself (both the actual cost of the generator and the fuel cost of adding the weight of the generator to the vehicle).

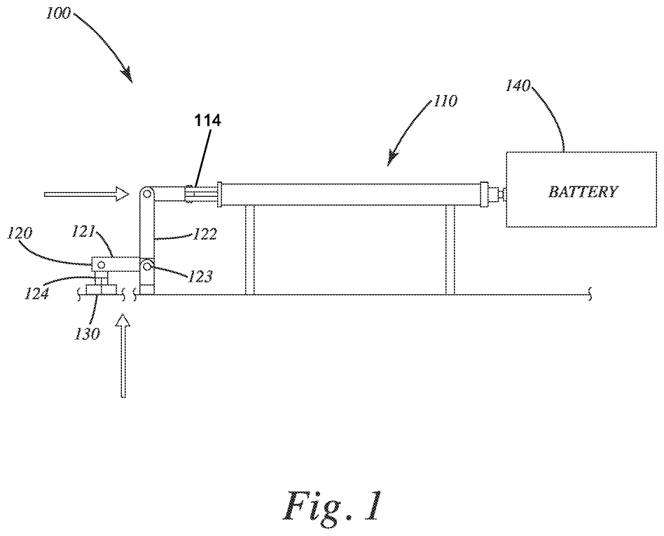

In FIG. 1, a magnified linear generator 100 according to one embodiment is shown. The terms generator, alternator, and similar terms are used interchangeably throughout this disclosure to mean a device that converts mechanical energy into electrical energy. The magnified linear generator 100 may include a generator 110 and a magnification device 120. The magnification device 120 may alternately be referred to as a mechanical amplifier. The generator 110 may include a stator 112 and a mover 114. In one aspect, the mover 114 may be referred to as an interior permanent magnet mover, a strut-generator mover, or an interior permanent magnet strut-generator mover. There may be an air gap between the stator 112 and the mover 114. As depicted in FIG. 1, the stator 112 and the mover 114 are internal to the generator 110 and are not shown. The stator 112 defines an opening and the mover 114 moves within the opening. In an alternate aspect, the mover 114 may define an opening to at least partially surround the stator 112.

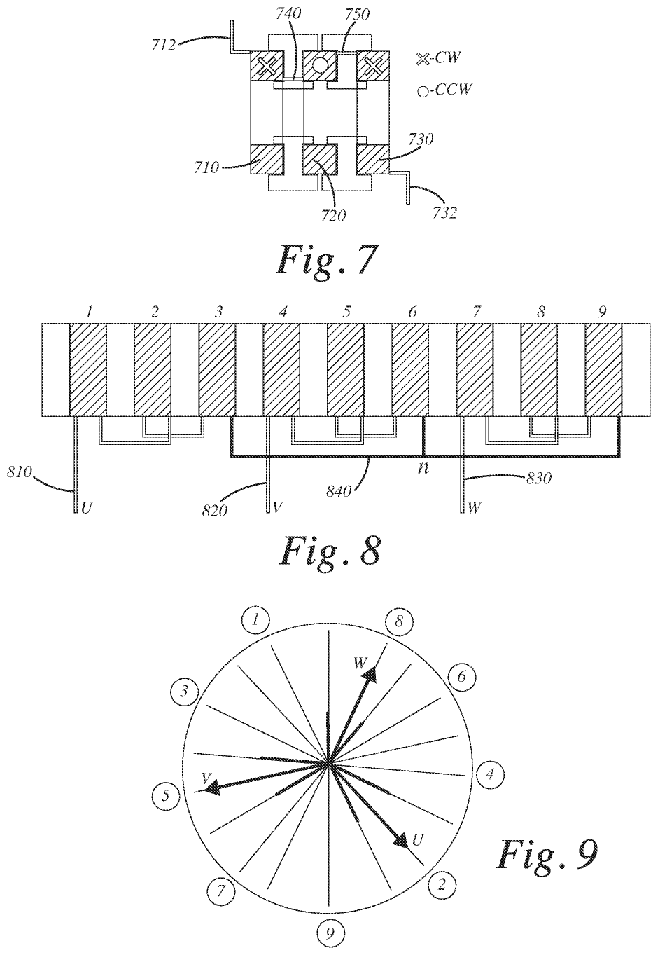

The generator 110 can convert input mechanical energy into electrical energy by moving the mover 114 along the stator 112. The mover 114 may be composed of a plurality of magnets spaced apart by a material and the stator 112 may have a plurality of electrical windings wound around a plurality of stator cups. In one aspect, the plurality of electrical windings are bobbin-wound windings. The stator 112 may have interconnection slots to connect the coils in each phase together. In one aspect, the interconnection slots may be cut on an inner bore of the stator assembly for connections between the coils and an outer diameter of the stator assembly for the output connections. An exemplary interconnection of the coils is shown and described with reference to FIGS. 7-8 below. In one aspect, the coils are made from copper. Each coil may be formed by a series of turns. In one aspect, each coil can have 48 turns. The number of turns may be determined by the available space for the coil, the weight each coil would add to the generator 110, or any other suitable factor.

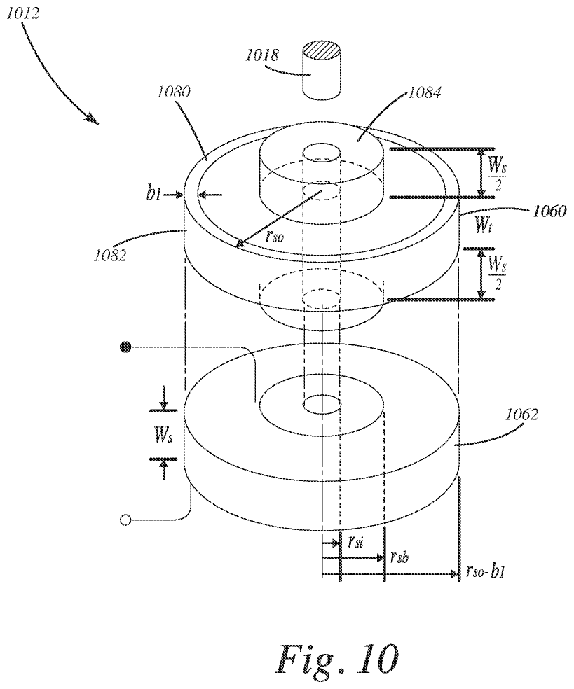

The stator cups may alternately be referred to as tooth cups. In one aspect, the stator cups 1060 are placed along a stator shaft 1018 as shown in FIG. 10. A winding 1062 may be stacked between two stator cups 1060. As shown in FIG. 10, the stator cups 1060 include a stator tooth overhang 1080, a stator shoe 1082, and a yoke 1084. In one aspect, the stator tooth overhang 1080 may extend from the surface of the stator cup 1060 to form a lip around the outer edge of the stator cup 1060. Put another way, the stator tooth overhang 1080 may be a protrusion extending from the surface of the stator cup 1060 in the direction of the yoke 1084. The stator tooth overhang 1080 may assist in retaining the winding 1062 on the stator shaft 1018. In one aspect, the stator tooth overhang 1080 may extend from both the upper and lower surface of the stator cup 1060 such that the stator tooth overhang 1080 may assist in retaining the windings 1062 stacked on either side of the stator cup 1060. In one aspect, the stator tooth overhang 1080 can lower detent (or cogging) force by reducing the magnetic reluctance variation as the mover magnets pass over each slot. In one aspect, the stator cups 1060 may be stacked along the stator shaft 1018 such that there is no air gap between the yokes 1084. The yokes 1084 may be magnetically in contact with one another. The stator cups 1060 may be configured to be stackable for ease of assembly and for use in different applications with different numbers of stator cups 1060 and windings 1062. In one aspect, nine windings 1062 and ten stator cups 1060 may be stacked together such that the stator 1012 terminates at both ends with a stator cup 1060. In an alternate aspect, any suitable number of stator cups 1060 may be stacked together. The stator cups 1060 may be made from a soft magnetic composite (SMC). In another aspect, the stator cups may be made from laminations. In one aspect, the stator cups 1060 may have a stator tooth overhang b₁ of 2 mm and a slot opening (put another way, the distance between the tooth shoes) of 2 mm. The stator 1012 may have semi-closed slots meaning that there is an opening in the stator slots. In contrast, the stator 1012 may have fully closed slots that act as a magnetic bridge and shunt some of the useable magnetic flux away from the windings 1062.

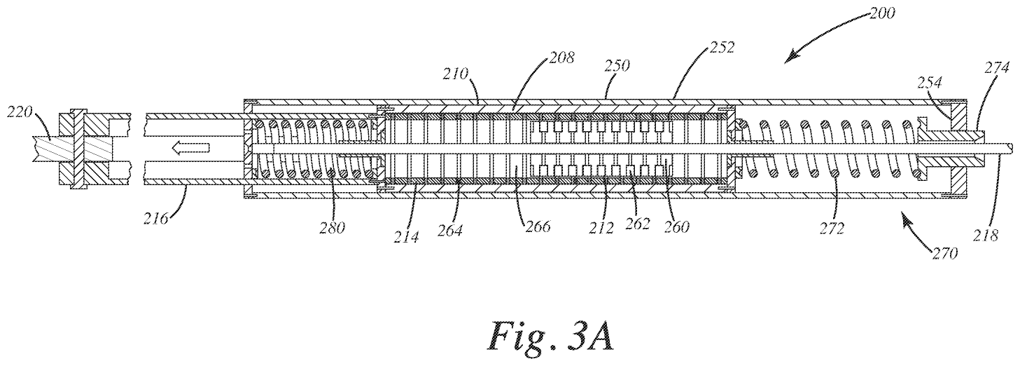

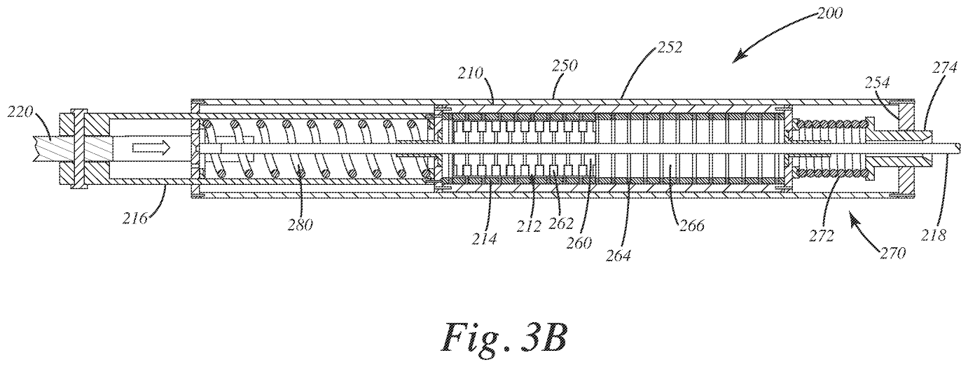

Returning to FIG. 1, in order to generate balanced three-phase electrical power, the stator 112 has a multiple of three electrical windings. In an alternate aspect, the mover 114 may contain the plurality of electrical windings and the stator 112 may include the plurality of magnets spaced apart by a material (shown and described below with reference to FIGS. 3A-3B). In one aspect, the material may be an SMC, such as Somaloy®. The material may be referred to as a pole shoe. Similar to the stator 112, the mover 114 is modular and may contain any number of magnets and pole shoes suitable for a given application. As the mover 114 moves along the stator 112, the magnetic field produced by the magnets induces an electrical current in the electrical windings. The induced electrical current may be balanced three-phase alternating current (AC). The generator 110 can output the AC power to an electrical power receptacle 140. In an alternate aspect, the generator 110 may be designed with any suitable number of phases. For example, the generator 110 may be a five-phase generator.

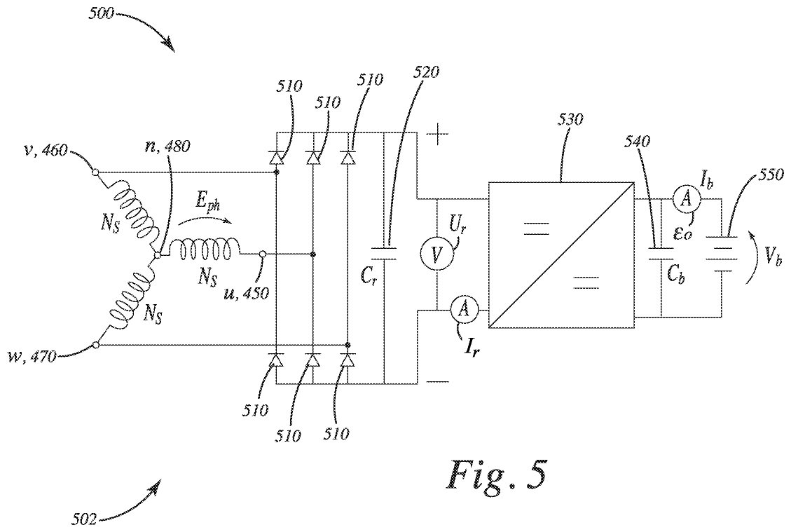

In many applications, the electrical power receptacle 140 may operate using direct current (DC) electrical power. Therefore, the AC power needs to be converted to DC power before use by the electrical power receptacle 140. There are many ways to convert AC power to DC power, one of which is described below with reference to FIG. 5. The AC-DC power conversion is not depicted in FIG. 1. As depicted in FIG. 1, the electrical power receptacle is a battery. In an alternate embodiment, the electrical power receptacle 140 may be an electric machine. Put another way, the generator 110 may be connected directly to an electric machine to power the electric machine without first storing the electrical energy elsewhere. Some examples of an electric machine include a drive motor on a vehicle, a drive motor on a refrigerator, or any number of electric motors or other electronics.

The magnification device 120 can be attached to the mover 114. As shown in FIG. 1, the magnification device 120 is a lever. The magnification device 120 may alternatively be referred to as an amplification device. The magnification device 120 may alternatively be a cam, a gear, or any other suitable type of mechanical magnification device. The magnification device 120 can increase the stroke of the generator 110 and make it easier to capture the energy due to the pole pitch configuration of the generator 110. The magnification device 120 has the same power input, Pᵢₙ, as power output, Pₒᵤₜ, at one hundred percent efficiency. The formula for power is

$$P = F * v$$

where F is the force and v is the velocity. In order to increase the output velocity, the magnification device 120 must decrease the output force relative to the input velocity and input force. For example, if the magnification device 120 has a magnification factor of 3:1, then Fₒᵤₜ=⅓*Fᵢₙ and vₒᵤₜ=3*vᵢₙ. In electrical terms, force translates to current and velocity translates to voltage. Therefore, increasing the velocity increases the output voltage of the generator 110. The magnification device 120 is designed to increase velocity so that the mover 114 goes through one, or more, full pole-pitch for each input force (for example, road movement). This may allow the generator 110 to more efficiently capture the input energy by increasing the output voltage.

The energy input into the magnification device 120 that is produced by the road vibration on an ISO 8608 B/C road has a small amplitude and a high frequency when compared to an ISO 8608 A road. For example, an ISO 8608 B/C road may have a displacement plus or minus 25 mm. Thus, the generator 110 may have an increase in velocity to capture that energy. An increased velocity can allow for a bigger pole pitch combination which may allow for more turns in each of the coils. Larger coils may increase the voltage output by the generator 110 thereby improving the ability of the generator 110 to output a larger amount of energy from the smaller amount of energy generated by the road vibration. The larger amount of energy can be stored in an electrical power receptacle 140 and/or used to power an electric machine. Additionally, the magnification device 120 can increase the velocity of the generator 110. In some aspects, the magnification device 120 may change the direction of an input force from a vertical axis to any desired orientation. An advantage of including the magnification device 120 is that the magnification of the velocity helps to overcome the weight of the magnified linear generator 100 and may allow the magnified linear generator to produce power in situations where a traditional generator would be unable to do so. Put another way, the velocity of a generator 110 affects its performance.

The magnification device 120 can be attached to a force receiving surface 130. The force receiving surface 130 may receive a force in the vertical direction and transfer that force to the magnification device 120. For example, the force receiving surface 130 may receive a force when the vehicle the magnified linear generator 100 is installed in goes over a bump. The magnification device 120 can take the power received from the force receiving surface 130 and magnify its velocity component before applying the magnified velocity to the mover 114. As shown in FIG. 1, the magnification device 120 translates the vertical received force into a horizontal force for use by the generator 110. In alternate embodiments, the generator 110 may be oriented vertically or at any other suitable angle and the magnification device 120 can be designed to translate the vertical force to the direction of the mover 114 of the generator 110. The magnified velocity allows the mover 114 to have a longer stroke than the received velocity would because the mover 114 is moving faster and can move further in the same amount of time. The magnified velocity therefore allows the generator 110 to more efficiently produce electrical power and thus produce more electrical power to output to the electrical power receptacle 140. Amplifying the stroke and velocity of generator 110 can tune the power generation system for voltage and efficiency and may reduce the size and diameter of the overall power generation system. Put another way, an increase in velocity may allow for a bigger pole pitch combination, which may allow for more winding material in the coil. An increase in winding material can improve the ability of the generator to capture the available energy from the road.

As shown in FIG. 1, the magnification device 120 has several portions that translate a vertical input force into a horizontal force for use by the generator 110. The magnification device 120 may include a first lever arm 121 and a second lever arm 122. The magnification device 120 can include an input force receiver 124 coupled to the force receiving surface 130 and one end of the first lever arm 121. A second end of the first lever arm 121 may be moveably coupled to a first end the second lever arm 122 at a fulcrum 123. A second end of the second lever arm 122 may be moveably coupled to the mover 114. In an alternate aspect, the magnification device 120 can include additional lever arms moveably coupled together. As shown in FIG. 1, when the force receiving surface 130 inputs an upward force to the input force receiver 124, the first lever arm 121 rotates clockwise about the fulcrum 123. The input force at the first lever arm 121 travels through the first lever arm 121 and into the second lever arm 122. As shown in FIG. 1, the clockwise rotation of the first lever arm 121 causes a clockwise rotation of the second lever arm 122 about the fulcrum 123. The force travels through the second lever arm 122 and into the mover 114 which moves the mover 114 into the stator 112 and translates the mechanical energy into electrical energy. In one example, the second lever arm 122 may be three times as long as the first lever arm 121, and therefore the magnification device 120 may increase the stroke and velocity of the linear generator 110 by a ratio of 3:1. Thus, one inch of mover 114 movement becomes three inches and the velocity triples from five Hertz to fifteen Hertz. In one aspect, the magnification factor of the magnification device 120 can be used to design the magnet pitch of the generator 110. In an alternate aspect, the design of the generator 110 can be used to design the magnification factor of the magnification device 120. In yet another aspect, the generator 110 and the magnification device 120 may be designed together to achieve a certain output voltage.

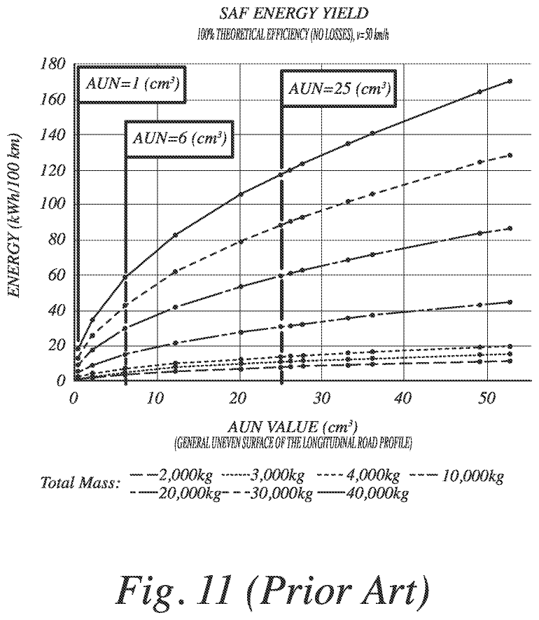

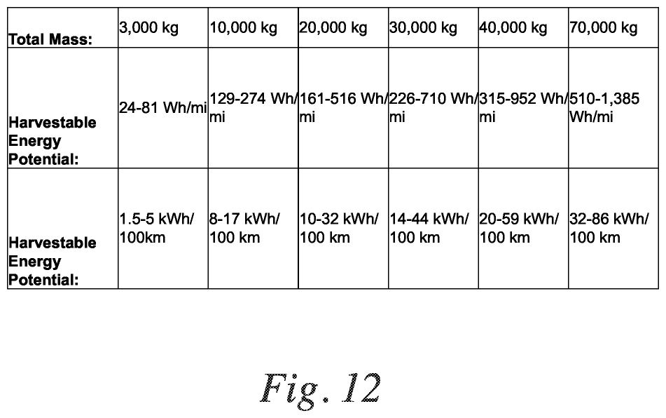

FIG. 11 is a prior art graph showing the available energy on paved roads. Most driving is done on an ISO 8608 B/C road with an AUN of 1 to 6, where AUN is a measure of the unevenness of the road. FIG. 12 is a chart showing road profile modeling and the harvestable energy potential of different masses. The modeling of FIG. 12 correlates well to the prior art data of FIG. 11. The modeled numbers in FIG. 12 are based on 15-25 mm displacement on any axled vehicle/trailer/train car. FIGS. 11 and 12 demonstrate that at different speeds, masses and terrain profiles are variable. Put another way, the available force is directly affected by the velocity of the force receiving surface (e.g. an axle) and the load on the axle. As the mass of the load and the speed increase, the available force and, therefore, the power production of the generator increases. A magnified linear generator can account for the variation through the magnification device and magnetic design of the generator.

A magnified linear generator 100 can collect a usable amount of energy on a wider range of road surfaces than a traditional PGS. The magnification device 120 may magnify the amount of velocity received from the force receiving surface 130 to magnify the stroke of the generator to allow the generator to produce more power. The generator 110 may be designed to maximize power production with minimal input force. For example, a magnification device 120 that magnifies the input velocity three times may more effectively produce energy in the ISO 8608 B/C road class, which is the classification of most roads.

The dampening requirement for vehicles is based on overall weight, both sprung and unsprung mass, and velocity. The dampening force is a combination of velocity, diameter, and distance travelled in the dampening mechanism. In the case of truck or similarly heavy vehicle or even a trailer the overall force requirement can be so high that the required generator is too big for the available space (also known as packaging). Utilizing a magnification device 120 to change the direction of motion into a different space on the vehicle with different packaging may allow the diameter of the generator 110 to be reduced by increasing the overall length. Put another way, the magnified velocity can move the mover 114 farther than the input velocity, so the generator 110 can be designed with a longer stroke due to this farther movement. Additionally, or alternatively, the use of a magnification device 120 to change the direction of an input force may allow the generator to be placed in a different orientation and potentially a different location with a different packaging space (for example, a different spatial orientation or a different size space). This may allow the magnified linear generator 100 to be used in existing vehicles without a costly vehicle redesign.

In one aspect, the packaging benefit combined with the electrical magnetic advantage in the design of the generator may make it possible for a magnified linear generator to capture 80% of the available energy in a targeted drive cycle. The electrical magnetic advantage in the design of the generator may alternately be referred to as the ability to design the generator characteristics for a particular application. In contrast, conventional systems may capture less than 40% of the available power. The targeted drive cycle may refer to the speed range of the vehicle that the magnified linear is designed to most efficiently operate in. For example, a magnified linear generator 100 including a generator 110 with a 9/8 fractional slot pole design that is designed for a vehicle traveling 65 miles per hour (mph) may utilize a magnification ratio of 3:1 whereas a magnified linear generator designed for a vehicle traveling 35 mph may utilize a magnification ratio of 7:1. In one aspect, the generator 110 may be designed with a 10/12 fractional pole slot design, an 18/24 fractional pole slot design, any other suitable fractional slot design, or any other suitable generator design that does not include a fractional slot. The pole, pitch, winding, and magnetics of a magnified linear generator can each be designed for specific road profiles, drive speeds, vehicle weights, and duty cycles to most efficiently capture the available energy. For example, a delivery truck completes most of its driving under 35 mph and frequently stops and starts which generates body sway. A magnification device can be calibrated along with the electromagnetics of a generator to focus on collection of the lost energy due to the slower speed and frequent starts and stops. As another example, a magnified linear generator for a train car may be designed to capture energy from a short stroke but highly repeatable vibration with high force loads.

In one aspect, the magnified linear generator may be part of a power generation system that includes monitoring capability. The system may monitor forces exerted on the force receiving surface (e.g. the vehicle suspension) and the power produced by the magnified linear generator. In one aspect, the system may perform this monitoring continuously. The system can record the monitored values and can log the power produced by the magnified linear generator versus the road location, speed of the vehicle, and weight of the vehicle. In one aspect, the system may record this data locally. Additionally, or alternatively, the system can include a communication module and transmit the data to an external server. The system may communicate using any suitable communication protocol (e.g. Bluetooth LTE) and may be part of an Internet of Things (IoT) network of devices. The communication to the external server may occur in real time, at specified time intervals, on demand, or at any other suitable time. In one aspect, the external server can be a cloud server or a private server.

The transmitted data may be accumulated and put into road profiles. The system may be part of a larger network of similar systems and the road profiles can be broadcast to other vehicles in the network. When a vehicle receives a road profile, the system installed in that vehicle may process the data in the road profile, analyze the weight of the vehicle and its speed, and calculate the power that can be produced going down the road corresponding to the road profile. These calculations can allow for the tuning of vehicle systems. For example, the system may apply more power to cooling or driveline. In another example, in a vehicle with a refrigerated trailer having a 20 kWh battery pack where the magnified linear generator is being used to generate power to cool the trailer, the system can perform calculations based on the road profile (which in turn may be based on a route entered into the system) and the weight of the vehicle to determine how much power the system can produce and how far the vehicle can travel while keeping the storage unit appropriately cold. As another example, if a vehicle is electric but the magnified linear generator is being used to power a different component (e.g. a refrigerated unit) rather than the vehicle itself, the system may recognize excess energy production based on the calculations and may send the excess power to the vehicle's drive system to increase range. In yet another example, the calculations can be used to predict the power production and plan the route of an electric vehicle with a relatively limited battery capacity.

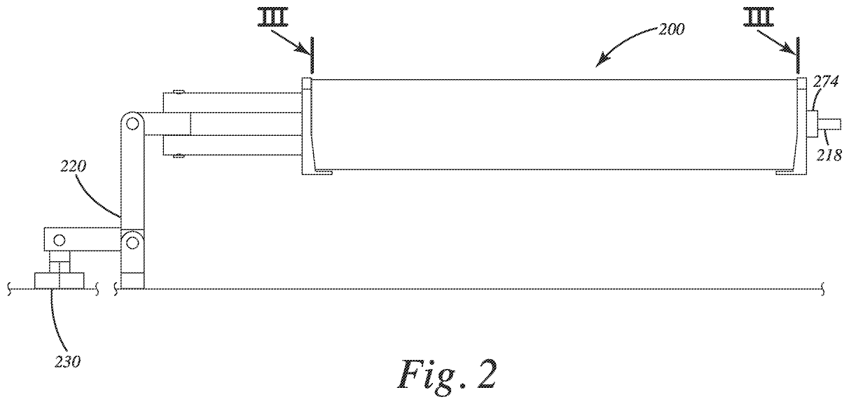

In FIG. 2, a side view of a magnified linear generator 200 according to one aspect is shown. Unless otherwise noted, the magnified linear generator 200 operates in the same manner as the magnified linear generator 100 of FIG. 1 with a 200 series reference numeral instead of a 100 series reference numeral. The magnified linear generator 200 may alternatively be referred to as a strut and may function as a vehicle strut. The force receiving surface 230 may be a vehicle suspension, but is not depicted as a vehicle suspension in FIG. 2. FIGS. 3A-3B show a cross-sectional view of the magnified linear generator 200 along the line III-III with a mover 214 of a generator 210 in two positions.

The magnified linear generator 200 may include a generator 210 coupled to a magnification device 220 through a mover coupling component 216. As depicted in FIGS. 3A-3B, the generator 210 may be surrounded by a casing 250 and the casing 250 may have a non-magnetic outer surface 252. A stator fixed shaft 218 can run the length of the casing 250 and the stator cups 260 with electrical windings 262 may be positioned along the stator fixed shaft 218. The electrical windings 262 may alternately be referred to as electrical coils. The mover 214 may have a plurality of magnets 264 separated by a material 266. As depicted, the magnets 264 and the material 266 are cylindrically shaped and the magnets 264 are axially magnetized. In one aspect, the material 266 may be referred to as an annular mover pole shoe. In one aspect, the magnets 264 may be recessed from the air gap by a recessed distance to minimize losses in the magnets 264 due to slotting. In one aspect, each magnet 264 can be a segmented magnet to reduce slotting ripple flux and consequent circumferential eddy currents that generate losses in the magnet 264. Put another way, each magnet 264 may be formed of multiple pieces that may be referred to as arc segments. For example, each magnet 264 may be split into three, four, five, or any suitable number of arc segments. The axial magnetization of the magnets 264 results in “T-shaped” magnetic flux lines where the magnetic flux travels toward the center of the stator 212 and through the center of the stator 212 away from the direction of movement of the mover 214.

In an alternate aspect, the magnets 264 may be surface mount radially magnetized magnets. Axially magnetized magnets 264 may be less expensive and have more uniform magnetization around their circumference because the magnetization more easily aligns with the magnet grain structure than surface mount radially magnetized magnets, which may allow more flux to interact with the stator 212. Axially magnetized magnets create a reluctance force in the mover 214 whereas radially magnetized magnets have minimal reluctance force. A mover 214 with axially magnetized magnets 264 and material 266 with a high permeability has sections with the permeability of air (the magnets 264) and sections of high permeability (the material 266). This configuration gives rise to stator 212 inductance that is a function of mover 214 position. When current flows in the stator 212, it interacts with the variable stator inductance to produce a reluctance force in addition to the force produced by the magnetic flux. In another aspect, the magnets 264 and the material 266 may be any other suitable shape. As depicted, the mover 214 is shaped to fully surround the stator 214 so that there are magnets 264 on top of the stator 212 at all times.

As depicted, the magnets 264 may be stacked in opposing magnetic pole patterns. For example, if the magnified linear generator 200 is oriented as shown in FIGS. 3A-3B, the first magnet 264 can be stacked N-S such that the South pole is against the left piece of material and the North pole is against the right piece of material, the second magnet 264 can be stacked such that the North pole is against the left piece of material and the South pole is against the right piece of material, and the pattern may continue for all of the magnets 264 included in the mover 214. The magnetic flux may travel through the material 666, into a stator tooth 680, down the center of the stator 212, out a second stator tooth 680, and into the next material 666. Put another way, the material 666 can allow flux to move to the stator 212 and the flux may continue to combine and transition across the air gap into the stator tooth 680. The magnetic flux is a closed loop. The path of the magnetic flux generates an electric current in the winding 262 between the two stator teeth 680. Magnetic flux can travel freely down the stator 212 because the stator 212 is made from a PM material. This may allow for larger magnetic fields that act over a larger area, which may allow for more efficient power production. In one aspect, a portion of the outer diameter of the material 266 may be removed without affecting the magnetic flux pattern because the magnetic flux does not travel all the way to the outer diameter. Instead, the magnetic flux bends into radial directed flux to reach a magnet 264. This can reduce the mass of the mover 214 and pole shoe losses. In one aspect, the portion of the outer diameter of the material 266 that is removed may result in a circumferential groove in the material 266.

The generator 210 may be surrounded by a housing 208. The housing 208 cannot be made from a magnetic material so that the housing 208 does not affect the magnetic flux pattern of the magnets 264. One exemplary material for the housing 208 is aluminum. In another aspect, the housing 208 may be made from any other suitable non-magnetic material. The generator 210 can be vacuum potted, meaning the mover 214 and/or the stator 212 may be vacuum potted. The vacuum potting may maintain the cylindricity of the generator 210 and maintain the inside diameter tolerances of the stator 212 and the mover 214. Maintaining the inside diameter tolerances of the generator 210 can allow for the generator 210 to be designed with a reduced air gap between the stator 212 and the mover 214. The vacuum potting compound may fill in any air voids in the mover 214 and make the mover 214 one piece of material. When the mover 214 is one piece of material, the mover 214 may be in constant tension and cannot vary dimensionally. The stator 212 may be similarly vacuum potted.

Put another way, the generator 210 can be manufactured in a manner that reduces the air gap and creates an additional full length bearing surface on the mover 214 and/or the stator 212. The mover 214 may be assembled by stacking the magnets 264 and the material 266 over a precision machined horn. The precision machined horn can make a concentric tight tolerance diameter for the full length of the mover 214. The mover 214 may then be vacuum potted to form one structural component. When the mover 214 is vacuum potted, a potting compound fills in the air gaps in the mover thereby making the mover 214 one solid piece that may be smooth with no lips or edges. Put another way, the precision machined horn may allow the potting compound to fill the air gaps on the inner surface of the mover 214 while also being flush with the precision machined horn such that when the horn is removed the inner surface of the mover 214 is smooth and the mover 214 is one solid piece. The stator 212 can be assembled and vacuum potted in a similar manner on a second precision machined horn that can make a concentric and tight tolerance for the full length of the stator 212. When the mover 214 and the stator 212 have been vacuum potted, their opposing surfaces are tightly controlled and this allows for a smaller air gap to be maintained within the generator 210. If the magnetic forces between the mover 214 and the stator 212 close the air gap, the potting compound can act as a load bearing surface to protect the components of the mover 214 and the stator 212. The surface with the potting compound may have low frictional forces thereby allowing the mover 214 to move along the stator 212 with less resistance.

The magnified linear generator 200 may also include a biasing component 270. The biasing component 270 may alternately be referred to as a balancing component. The biasing component 270 can include a compressible material 272. As depicted in FIGS. 3A-3B, the compressible material 272 is a coil spring. In alternate aspects, the compressible material 272 may be a multi-rate bushing or any other suitable compressible material. The compressible material 272 applies a biasing force to the mover 214 and biases the mover 214 to a neutral location within the casing 250. The magnified velocity and reduced output force from the magnification device 220 can overcome the biasing force to move the mover 214 from its location in FIG. 3A to its location in FIG. 3B which induces an electrical current in the stator 212 and results in output electric power. The compressible material 272 provides a constant tension on the mover 214 that allows the generator 210 to operate with a variable stroke. The biasing component 270 can assist the mover 214 in staying in line with the stator 212.

As depicted in FIGS. 3A-3B, the compressible material 272 is attached at a distal end of the casing to a spring tensioner 274. The spring tensioner 274 can be used to change the tension of the compressible material 272 and thereby change the amount of biasing force applied to the mover 214. In one aspect, a motor may be attached to the spring tensioner 274 to mechanically change the tension in the compressible material 272 by moving the spring tensioner forward or backward with or without an additional mechanical magnification device such as a gear. additionally, or alternatively, the spring tensioner 274 and/or motor may be attached to a controller. The controller may include software that automatically adjusts the tension in the compressible material 272 according to a road profile, vehicle make/model, or any other suitable criteria. Additionally, or alternatively, a user can configure the controller through a suitable device and communication profile to adjust the tension in the compressible material 272. In another aspect, the tension in the compressible material 272 may be static. For example, the compressible material 272 may be attached at one end to the mover 214 and at the other end to the inner portion 254 of the distal end of the casing 252. The biasing component 270 can maintain a load level and level point of the suspension system. The biasing component 270 may also increase or decrease the response rate of the generator 210 based on the compression of compressible material 272. The magnified linear generator 200 can be tuned for variable speed, displacement, and load which may allow the magnified liner generator 200 to efficiently produce power.

In one aspect, the spring tensioner 274 may be a helically wound component threaded into a threaded opening in the casing 250. The spring tensioner 274 may also be coupled to a rotary motor (not shown). The rotary motor may drive the spring tensioner 274 inward to increase the tension on the compressible material 272 thereby increasing the biasing force on the mover 214. The rotary motor may drive the spring tensioner 274 outward to reduce the tension on the compressible material 272 thereby decreasing the biasing force on the mover 214.

In one aspect, the casing 250 may define at least one opening in at least one of its proximal and distal end. The at least one opening can prevent the magnified linear generator 200 from becoming an air pump by providing a way for air to escape the casing 250. In one aspect, the casing 250 may define at least one opening in each of its proximal and distal end. These opening may provide air flow to be able to cool the generator 210. In one aspect, the air forced out of the casing 250 through the at least one hole may be utilized to power an additional power generation device.

Optionally, the magnified linear generator 200 may include an input compressible material 280 between a proximal end of the casing 250 and the mover 214. As shown in FIGS. 3A-3B, the input compressible material 280 is a spring. In another aspect, the input compressible material 280 may be any suitable compressible material. The input compressible material 280 may assist the mover coupling component 216 of the magnification device to smoothly move the mover 214 within the casing 250.

In one aspect, the generator 210 may be designed with both a modular stator 212 and a modular mover 214. The modular stator 212 can include stator cups 260 designed to fit electrical coils 262, and the number of stator cups and coils stacked together to form the stator 212 may vary depending on the application. The modular mover 214 can include a permanent magnet (PM) material and axial charged ring magnets, and the number of PM material and axial charged magnets stacked together to form the mover 214 may vary depending on the application. The modularity of the components results in less types of components to manufacture and may improve the speed and ease of assembly. Modular components also allow the generator design to be adjusted because the number of poles and the number of coils per phase can be changed by adding or subtracting a modular component from the stator 212 or the mover 214.

In vehicles that utilize pneumatic tires (such as rubber tires), a large portion of the available road energy may be dampened and thereby dissipated by the tire sidewalls. A magnified linear generator 200 with a magnification device 220 coupled to the axle of the rubber tire can absorb some of the energy that would otherwise be dampened, magnify it, and output it to an electrical power receptacle.

In one aspect, a magnified linear generator 200 can be used as part of an active suspension in a vehicle to stabilize the vehicle. The magnified linear generator 200 may be selectively configurable to operate as described above or to operate as part of an active suspension in a vehicle. When the magnified linear generator 200 is operating as part of the active suspension, a bidirectional power inverter (not shown) may be included between the stator 212 and the electrical power receptacle (not shown) to allow power to be selectively supplied to or supplied by the generator 210. For example, if the front tire of the vehicle hits a bump, the known speed of the vehicle can be used to power the generator 210 to move the rear tire before it hits the same bump. In one aspect, the movement of the rear tire may occur milliseconds before the rear tire would have contacted the bump. The biasing component 270 may be used to increase or decrease the resistance on the mover 214 of the generator 210 to respond to a variety of vehicle operation conditions (e.g. varying road quality, vehicle cornering, etc.).

The magnified linear power generation system described herein can be used in a number of different applications. A description of an exemplary magnified linear generator as well as exemplary implementations of a magnified linear generator in semi-trailers, micro-mobility applications, and refrigerated containers follows. These applications are in no way an exhaustive list of the possible applications for a magnified linear power generator.

### I. An Exemplary Magnified Linear Generator

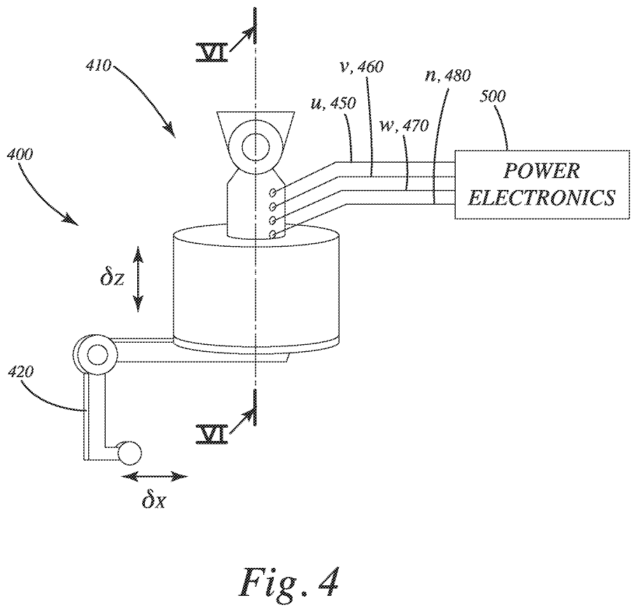

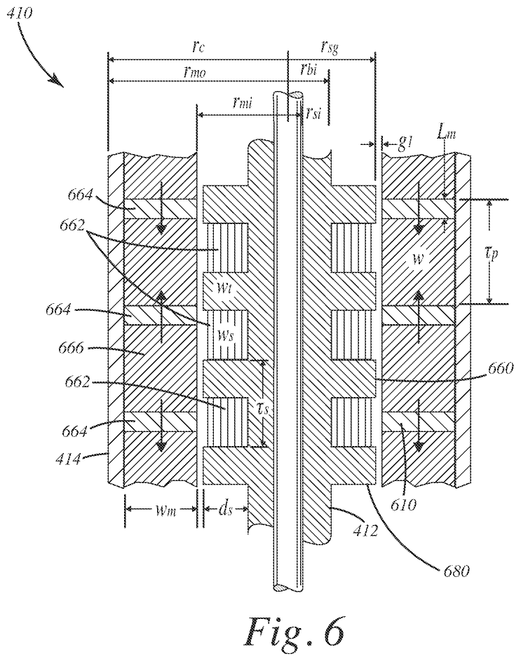

In FIG. 4, a magnified linear generator 400 according to one embodiment is shown. The magnified linear generator 400 has a magnification device 420 coupled to a mover 414 (depicted in FIG. 6) of a generator 410. As depicted, the magnification device 420 is a lever with a pivot. The magnification device 420 can receive a horizontal displacement δx and magnify and transfer it to the mover 414 as a vertical displacement δz. Put another way, a linear, permanent magnet, reciprocating alternator 410 can be driven through a mechanical mechanism 420 providing proportionally boosted linear velocities and corresponding diminished force levels for the efficient generation of electricity. In one aspect, 12≤δx≤25 mm of movement and the magnification device 420 may magnify the horizontal velocity δx by a ratio of 3:1 such that 36≤δz≤75 mm of movement. As shown in FIG. 6, the mover 414 may move vertically along a stator 412 to produce electrical power. The generator 410 may be designed to output alternating current (AC) power or direct current (DC) power. As depicted in FIG. 4, the generator 410 produces AC power in three-phase windings u, 450, v, 460, and w, 470 and a neutral n, 480. Many electric machines require DC power to operate, so the output AC power from the generator 410 must be converted to DC power at some point to power an electric machine, which can happen in many ways. As depicted in FIG. 4, the three-phase AC power is passed to a set of power electronics 500 that includes an AC-DC converter 502 (shown in FIG. 5) that converts the AC power to DC power for storage or use by an electric machine. In one aspect, the electric machine may be driving a refrigeration pump to maintain a shipping container at a suitable temperature. The power electronics 500 may be separately connected to an electrical power receptacle or may include an electrical power receptacle as shown in FIG. 5. In one aspect, Z. (the length of a pole pair) is 55.5 nominal at a frequency, f, approximately equal to 5 Hertz and a diameter of 150 mm.

In FIG. 5, an electrical circuit diagram of the power electronics 500 according to one exemplary embodiment is shown. The power electronics 500 include the AC-DC converter 502. As depicted in FIG. 5, the AC-DC converter 502 may be referred to as a full wave rectifier. The three-phase AC windings u, 450, v, 460, and w, 470 and the neutral n, 480 act as inputs to the AC-DC converter 502. The three-phase windings are connected in a wye-connection to a full-bridge voltage rectifier made up of diodes 510. In one aspect, the diodes 510 are silicon PN diodes. The full bridge rectifier converts the AC input voltage to a DC voltage that charges a capacitor 520. The voltage across the capacitor 520 powers a boost converter 530 which takes an input DC voltage and outputs a larger DC voltage. In one aspect, the boost converter 530 may be connected to a circuit and/or software to vary the effective resistance in the boost converter 530 to maximize power production. The effective damping produced by the magnified linear generator 400 may be controlled by controlling the input current Iᵣ in proportion to the input voltage Uᵣ. Put another way, the input current Iᵣ may be controlled to maximize the power output and/or to realize a fixed or variable damping effect. For example, in a passenger vehicle, the damping of a magnified linear generator 400 may be designed to minimize passenger compartment z-axis acceleration to improve the comfort and ride quality of the vehicle passengers.

Returning to FIG. 5, the output voltage is stored in capacitor 540 which results in an output voltage V_{b} 550. In one aspect, the output voltage V_{b} 550 is the voltage stored in an electric power receptacle. In one aspect, the boost converter 530 operates such that

$$2 \leq \frac{{V}_{b}}{{V}_{r}} \leq 5 \\ {G}_{v} = \frac{{V}_{b}}{{V}_{r}}$$

meaning the boost converter 530 increases the voltage by a factor between 2 and 5.

In FIG. 6, a cross-sectional view of the generator 410 of FIG. 4 along the line VI-VI is shown. The mover 414 may include magnets 664 and a material forming pole shoes in between the magnets 664. In one aspect, the material is a soft magnetic composite (SMC), such as Somaloy®. As depicted in FIG. 6, the magnets 664 are disk-shaped (for example, washers) and axially polarized. In an alternative aspect, the magnets may be surface magnets or any other suitable type of magnet. The mover 414 can surround the stator 412. The stator 412 may have windings 662. In one aspect, the stator 412 may be formed from stator cups which the wire may be wound around to form bobbin windings (as shown below in FIG. 10). The stator cups may be made from SMC or any other suitable material. The preferred magnified linear generator 410 includes a fractional slot concentrated winding (FSCW) stator 412 having round, tape, or bar conductor bobbin windings 662 so interconnected that balanced three-phase voltages are produced when the permanent magnet mover 414 is operated. The following equations are used in the design of the generator 410.

$${τ}_{p} = \frac{{Z}_{0}}{2} \\ {W}_{m} = tbd \\ L = P {τ}_{p} + W \\ W = {τ}_{p} - {L}_{m} \\ {L}_{m} = 3 \\ {τ}_{p} = 28 \\ W = 25 \\ L = 249 \\ {τ}_{s} = \frac{P}{Q} {τ}_{p} = 24.89 \\ {W}_{t} = 0.46 {τ}_{s} = 11.45 \\ {W}_{s} = 13.44 \\ {r}_{c} = 75$$

The stator 412 and the magnets 664 together form a 3/8 slot/pole/phase winding with high winding factor of the fundamental frequency that minimizes harmonic content. Thus, the generator is designed with fractional slot concentrated windings (FSCW). Efficient assembly is ensured through segmentation of stator soft magnetic composite or powdered metal cups for teeth and yoke, plus bobbin wound coils contained within a steel outer case. The mover consists of axially magnetized permanent magnet washers axially stacked with soft magnetic composite pole shoes all assembled onto a non-ferrous structural mover so that working air gap uniformity, concentricity, and flexing are insured over the full working space of mover velocity and thrust levels.

In an alternate aspect, a different slot/pole/phase rating may be used in the generator design. For example, any configuration where the phase voltages are 120° apart and the coils are clustered together may be a valid generator design to produce balanced three-phase output power.

As shown in FIG. 10, the stator 412 may accommodate a suitable number of stator cups with a bobbin winding sandwiched between two stator cups. In this example, the stator 412 may accommodate 9 bobbins each including a bobbin winding. In this example, each power phase includes three bobbin windings and each phase may be connected as shown in FIG. 7. In FIG. 7, a stack of three coils 710, 720, 730 is shown. Each stack of coils constitutes one phase of the three-phase linear actuator. As shown in FIG. 4, the actuator cross-section is circular. In an alternate aspect, the actuator cross-section may be ellipsoidal, rectangular, square, or any other suitable shape.

In FIG. 7, the first coil 710 is inserted so the top connection has turns in a clockwise (CW) direction. The outer connection 712 of the first coil carries the output power for the phase. The second coil 720 may be identically wound but flipped on insertion in the stator cup so that the middle connection has turns in a counterclockwise (CCW) direction. The inner connection of the first coil and the inner connection of the second coil may be directly connected at 740. The third coil 730 may be identically wound and inserted the same way as the first coil so that the bottom connection has turns in a CW direction. The outer connection of the second coil and the outer connection of the third coil may be directly connected at 750. The inner connection 732 of the third coil can be connected to the inner connection of the third coil of each of the other two phases and may be output as the neutral connection for the output power.

In other configurations with a different number of windings, the connection may occur in the same way or any other suitable manner for the particular application. For example, in the case of a stator consisting of flat plates the bobbin type windings would revert to those of a conventional FSCW electric machine with each coil wound on one stator tooth.

In this example, the generator is an interior PM fractional slot concentrated winding tubular strut-generator. The minimum assembly for this example generator contains three of the phase groups of FIG. 7. The overall interconnection of the windings is shown in FIG. 8. Each of the bobbin windings are labelled 1 to 9. The three phases u, 810; v, 820; and w, 830 are shown connected in a wye connection with a neutral connection n, 840. The interconnections between the coils are shown to highlight the winding reversals.

For a slot/pole/phase of 3/8, the mover corresponding to the stator of FIG. 8 has 8 PMs separated by pieces of SMC material with a width, W. The mover assembly may also have end pieces before the first PM and after the eighth PM with a width of W/2. In this example generator, the PMs have axial magnetization and are arranged along the moved such that alternate magnet polarizations are reversed. The mover magnetizations would be (N,S)-(S,N)-(N,S) etc. The span of the mover with 8 permanent magnets, call its length Xₘ, matches the length of the stator stack, call it Xₛ, so that the number of slots/pole/phase:

$$SPP = q = \frac{Q}{mP} = \frac{9}{3 * 8} = \frac{3}{8}$$

When the windings are connected as shown in FIG. 8 the star of slots in FIG. 9 shows balanced magnetomotive force (MMF). When the mover moves along the stator the coils are excited and a balanced three-phase voltage is generated.

FIG. 9 shows the star of slots diagram for the FSCW actuator which shows balanced operation of the FSCW actuator. In FIG. 9, a unit current (for example, 1 Ampere) is applied to the applied to the windings of FIG. 8 which have the coil arrangement of FIG. 7. Note that mechanically if the stator were wrapped around a mandrel the 9 slots would each be 40° from each other. Electrically, for a P pole design with Q slots, the electrical slot angle may be calculated as

$$α = \frac{P}{2} * \frac{360}{Q} = 160 °$$

For example, the current into slot 1 is negative so appears as shown in FIG. 9. The resultants for all 9 slots are shown, one color for each phase. The angle between phasors in FIG. 9 is 20° and the resultant for all three phasors in a phase denoted with respective phase letter.

The star of slots diagram of FIG. 9 facilitates computation of the winding factor for pitch and distribution factors. The formula for the winding factor is:

$${k}_{w} = {k}_{p} * {k}_{d}$$

For example, a winding factor of 0.96 is very good. The example FSCW generator with slot-pole-phase (SPP) of 3/8 is electrically efficient having winding factor k_{w}=kₚ*k_{d}=0.9597. This is comparable to a conventional radial magnetization permanent magnet synchronous motor (PMSM) with SPP of 2 and 5/6^{th} coil pitch. The example FSCW generator also has harmonic reduction.

In the case of the FSCW linear actuator and referring to FIG. 9 the overall winding factor of phase u (identical for phases v and w by symmetry) is:

$${k}_{w} = \frac{1 + cos 20 + cos - 20}{1 + 1 + 1} = \frac{2.879}{3} = 0.9597$$

This is because each of the 9 slot sectors shown in FIG. 9 are 40° subject to 4-turns or 160° electrically. Slot currents are then shown in FIG. 9 with magnitude 1 in each slot radial plus magnitude 1 on the bisecting radial displaced 20° from each of those. Hence the computation shown above.

Put another way, the electrical slot angle is 160°. With reference to phase U in FIG. 9, slot 1 is at 160° electrical, slot 2 is at 320° electrical) (2*160°, and slot 3 is at 480° electrical) (3*160°. The slot voltage is collected by connecting three bobbin windings 662 (one in each of the slots) in series. So, one bobbin winding is at 160°, a second is at 140° (320−180), and a third is at 120° (480−360). Thus, phase U is comprised of voltages at 140° plus or minus 20°. Phase U can be viewed as two bobbin coils 662 wound in the CW direction and one bobbin coil 662 wound in the CCW direction. The bobbin coil 662 in the CCW direction has a 180° change from each adjacent bobbin because of the reversal of winding direction, and thus explains the calculations for the electrical angle of each of the three windings 662. The currents in FIG. 9 are considered a unit current (for example, 1 Ampere). If an inner circle were drawn on FIG. 9, then phase U would add vectorially for a winding factor of k_{w}=(1+2*cos(20))/3=0.9597. The winding factor multiplied by the coil turns (N_{c}) or total series turns (Nₛ) is the effective number of turns. Put another way, the effective number of turns is k_{w}*N_{c} or k_{w}*Nₛ. Everything discussed above for phase U can be done similarly for phase V and phase W. In an alternate aspect, the FSCW generator can be designed with a different slot-pole number and pole pitch combination to suit another application.

The magnetic factor, k_{ϕ}, of the FSCW linear actuator is dependent on the axial width of both magnet, Lₘ, and pole shoe, W, where

$$W + {L}_{m} = {τ}_{p} = 28.5 mm$$

and τₚ is the pole pitch. Using 3 mm for Lₘ the magnetic factor

$${k}_{φ} = \frac{4}{π} * cos [ \frac{{L}_{m}}{{τ}_{p}} * \frac{π}{2} ] = 1.256$$

The strut generator will develop a phase voltage, Eₚₕ, that is dependent on total series turns/phase, Ns, the air gap flux, ϕ_{g}, the winding factor, the magnetic factor, and the frequency of the mover, f. Therefore, the goal is to maximize the phase voltage, and the phase voltage is calculated as:

$${E}_{p h} = \sqrt{2} * π * {k}_{φ} * {k}_{w} * f * {N}_{s} * {φ}_{g}$$

At a nominal f=5 Hz mover operation the phase voltage Eₚₕ=26.78*Nₛ*ϕ_{g}. Thus, the air gap flux from the magnets must be maximized in order to minimize the total series turns and result in a maximized phase voltage.

For example, a 48V battery is to be charged by the FSCW linear generator. For a three-phase linear generator the corresponding phase voltage

$${E}_{p h} = ( \frac{π}{3} * \sqrt{6} ) * 48 = 20.5 V rms$$

As stated above, the example generator is a buried magnet, FSCW generator with a mover containing magnets being moved over the three-phase stator. The phase voltages are developed as:

$${e}_{p h} = \sqrt{2} π ( {k}_{w} - {k}_{φ} ) {N}_{s} f {ϕ}_{φ} V rms$$

$${V}_{r} = \frac{3 \sqrt{6}}{π} {e}_{p h} {V}_{d c} average$$

$${V}_{r} = 2.339 {e}_{p h} = {k}_{3} {e}_{p h}$$

So, to maximize ϕ_{g}

$${V}_{b} \approx {G}_{v} {k}_{3} ( \sqrt{2} π {k}_{w} {k}_{φ} ) {N}_{s} f {φ}_{g}$$

where Gᵥ is the boost converter gain to match three-phase rectified voltage Vᵣ to battery V_{b} (or to some application).

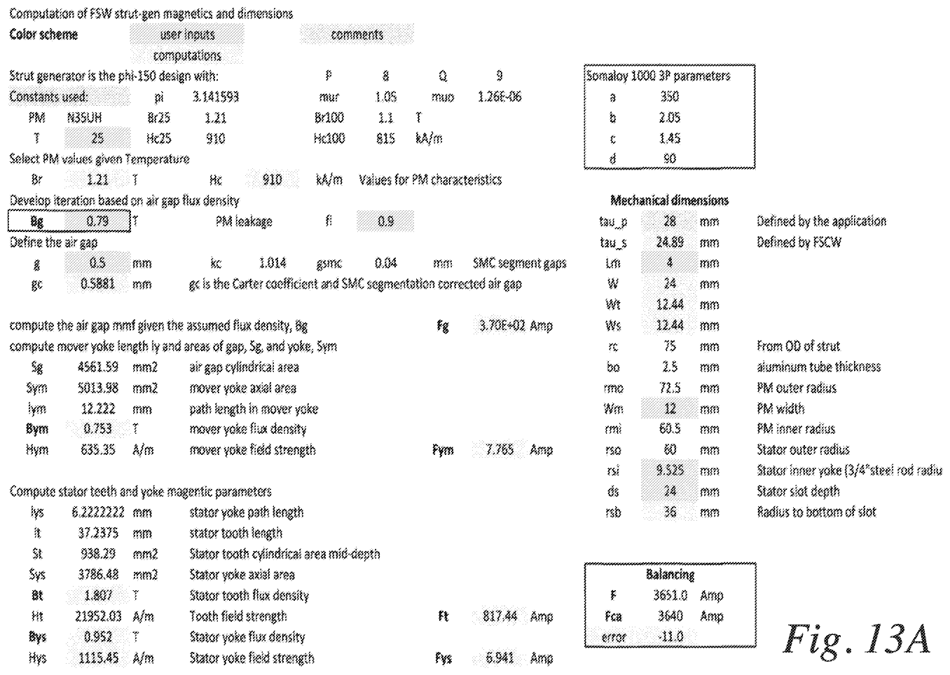

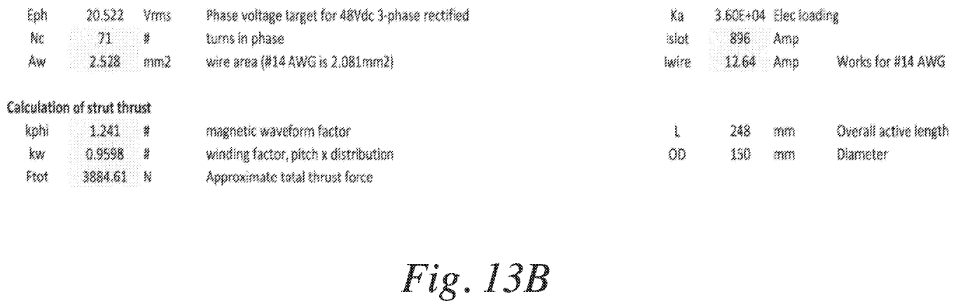

FIGS. 13A-13B contain exemplary magnetics modeling for Somaloy® 1000-3P reluctivity. The formula for determining the magnetic field strength (A/m) is:

$$H ( B ) = a cosh ( b {B}^{c} ) - d$$

Calculating the Carter coefficient of slots with flux path/pole encounters f=2 and stator cup segment gap of g_{smc}=0.04 mm:

$${g}_{c} = {k}_{c} ( g + f {g}_{smc} ) = 1.014 ( 0.5 + 2 ( 0.04 ) ) = 0.59 mm$$

FIGS. 13A-13B show the results of summing the MMFs along the flux path by iterating on gap flux density B_{g}. These results do not include consideration of tracking and predicting available road energy.

$${F}_{g} = \frac{{B}_{g}}{{μ}_{o}} {g}_{c}$$

Mover yoke mmf F_{ym}:

$${F}_{y m} = {H}_{y} ( {B}_{g} ) {l}_{y} = [ a cosh ( b {B}_{ym}^{c} ) - d ] {l}_{ym}$$

Length

$${l}_{y} = \frac{w}{4} + \frac{{w}_{m}}{2} ; where w = 25$$

$${l}_{y} = 6.25 + \frac{{w}_{m}}{2}$$

Air gap area:

$${S}_{g} = 2 π {r}_{mi} \frac{w}{2}$$

### So,

$${S}_{g} = π {r}_{m i} w$$

$$And$$

$${S}_{y m} = π ( {r}_{m o}^{2} - {r}_{m i}^{2} )$$

### So,

$${B}_{y m} = \frac{2 {S}_{g}}{{S}_{g} + {S}_{y m}} {B}_{g}$$

Stator teeth and yoke

$${l}_{t} = {d}_{s} + \frac{{d}_{s y}}{2}$$

$${l}_{ys} = \frac{{w}_{s}}{2}$$

$${l}_{t} = {r}_{s b} - {r}_{b i} + \frac{1}{2} ( {r}_{bi} - {r}_{s i} ) = {r}_{s b} - 0.5 {r}_{b i} - 0.5 {r}_{s i}$$

$${s}_{t} = 2 π {w}_{t} \frac{{r}_{s o} - {r}_{s b}}{2}$$

$${S}_{y s} = π ( {r}_{b i}^{2} - {r}_{s i}^{2} )$$

Stator teeth and yoke mmf
Balance flux in single path

$${B}_{t} {S}_{t} ( 1 + \frac{θ}{P} ) ≅ {B}_{g} {S}_{g}$$

### So,

$${B}_{t} = \frac{{S}_{g} {B}_{g}}{{S}_{t} ( 1 + \frac{Q}{P} )}$$

$$and$$

$${H}_{t} ( {B}_{g} ) = [ a cosh ( b {B}_{t}^{c} ) - d ]$$

$${F}_{t} = {H}_{t} ( {B}_{g} ) {l}_{t}$$

$${B}_{y s} {S}_{y s} = {B}_{g} {S}_{g}$$

$${B}_{y s} = \frac{{S}_{g}}{{S}_{y s}} {B}_{g}$$

$${l}_{ys} = \frac{{w}_{s}}{2}$$

$${F}_{y s} = {H}_{y s} ( {B}_{g} ) {l}_{y s} = [ a cosh ( b {B}_{t}^{c} ) - d ] {l}_{y s}$$

Balance mmf's along ½ path
PM mmf f₁=0.9 leakage factor
Magnet area=S_{ym} from earlier

$${B}_{m} = ( \frac{{B}_{g}}{{f}_{l}} ) ( \frac{{S}_{g}}{{S}_{ym}} )$$

$${H}_{m} = ABS ( {B}_{r} - {B}_{m} ) \frac{1}{{μ}_{r} {μ}_{o}}$$

$${F}_{m} = {H}_{m} ( {B}_{g} ) {L}_{m}$$

Therefore, |Fₑₐ−ΣF|<ε; where ΣFₙ=2(F_{ym}+F_{g}+Fₜ+F_{ys})+Fₘ.

Electrical design

$$Slot area : {A}_{s} = {d}_{s} {w}_{s}$$

$${J}_{c u} = 5 A / {mm}^{2}$$

$${k}_{fill} = 0.6$$

$${A}_{s} = 2 98.6 {mm}^{2}$$

$${I}_{slot} = {k}_{fill} {J}_{c u} {A}_{s} = 895.7 Amp$$

$$K = {k}_{fill} {J}_{c u} ( {r}_{s o} - {r}_{s b} )$$

$$K = {I}_{slot} / {τ}_{s} = ( 89 5.7 / 24.89 ) 1 {0}^{3} = 36 kA / m$$

$$From earlier {e}_{p h} = 5.355 f {N}_{s} {ϕ}_{g} ; where f = 5 Hz ; {ϕ}_{g} = {B}_{g} {S}_{g}$$

$$yields {N}_{c} = 71 t / phase for$$

$${A}_{w} = \frac{{k}_{fill} {A}_{s}}{{N}_{c}} = 2.5 \; 28 {mm}^{2}$$

$$Approximate thrust force {1}_{m} = 4$$

$${J}_{c} = 5 A / {mm}^{2}$$

$$F = π {Pk}_{φ} {k}_{w} {B}_{g} {K}_{a} {S}_{g} = 8 π ( 1.256 ) ( 0.9597 ) ( 0.79 ) ( 36 * 1 {0}^{3} ) ( 9.562 * 1 {0}^{- 3} ) = 3930 N$$

Excel Results when Lₘ=4; J=25° C.; g=0.5 mm
B_{g}=0.79 T air gap
B_{ym}=0.753 T mover yoke, SMC
Bₜ=1.807 T stator tooth, SMC←Saturation
B_{ys}=0.952 T stator yoke

In alternate embodiments, the magnified linear generator may be designed for other applications.

### II. Semi Trailers

Semi trailers are traditionally towed by a truck and do not have a power source. Thus, when the cargo needs to be refrigerated, a diesel or gas generator is often incorporated into the trailer to provide the necessary power. A magnified linear generator may be incorporated in a semi truck with a hybrid drive train to provide a regenerative suspension system for trailers.

An exemplary known system may incorporate one or more electric motors with or without a gear box (e.g. transaxle) with or without differential axles to both boost a trailer and be used for regenerative breaking. The system may be combined with a power source (e.g. a battery) which is used to drive the one or more electric motors and as a collection point for any energy produced from regenerative breaking. In addition, a power generating suspension (struts, shocks, springs) can be used to capture energy from the movement of the suspension and turn it into electrical energy through a linear or rotary generator. This road energy may be stored in a battery pack and used to power the drive motors or other auxiliary systems including refrigeration systems and other power consuming electronics.

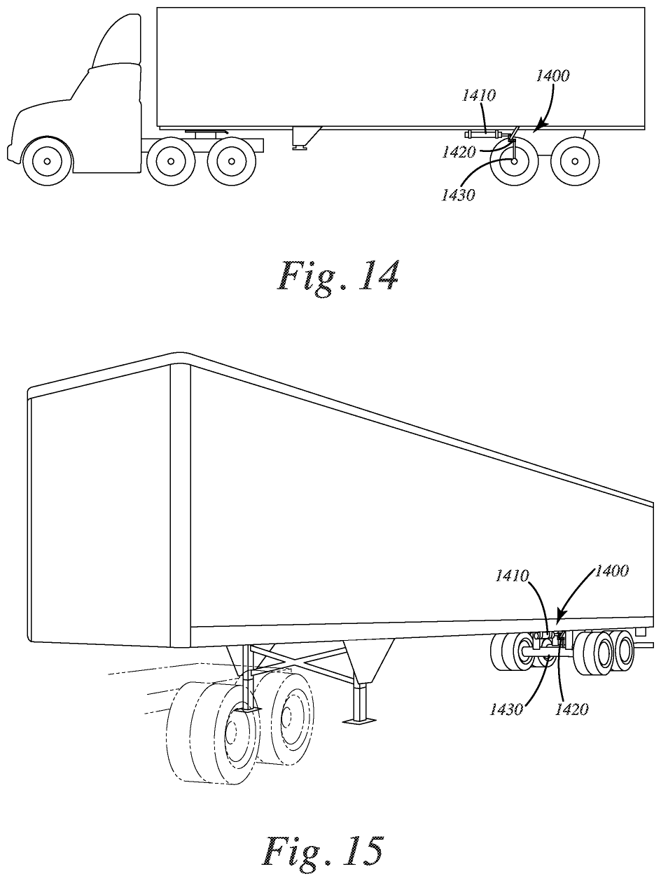

In FIGS. 14-15, a magnified linear generator 1400 incorporated into a semi trailer is shown according to two aspects. The magnified linear generator 1400 may be coupled to any suitable force receiving surface 1430 of the semi trailer. The magnified linear generator 1400 can be incorporated in a semi truck's suspension to as part of a PGS to produce power from road energy. The magnified linear generator 1400 may have a magnification device 1420 coupled to a linear generator 1410 to increase the stroke and velocity of the generator 1410. Additionally, the magnification device 1420 may change the direction of input force from the truck bed from vertical to horizontal or anything in between. As depicted in FIGS. 14, the magnification device 1420 is coupled to one of the wheels of the semi trailer. As depicted in FIG. 15, the magnification device 1420 is attached to an axle between two rear wheels of the semi trailer. The linear generator 1410 may be attached to the semi trailer itself and run fore aft on the trailer. As shown in FIGS. 14-15, the magnification device 1420 translates the vertical input force to a horizontal force that magnifies the velocity of the linear generator 1410. The magnified linear generator 1400 may include a biasing component (not pictured) to bias the mover to a neutral position in the magnified linear generator 1400. The magnified linear generator 1400 can be used to charge a battery pack (not shown) and the battery pack may power components of the trailer or the semi truck itself. While FIGS. 14-15 depict one magnified linear generator 1400 coupled to one wheel of the semi trailer, a magnified linear generator 1400 may be coupled to each wheel. Therefore, for the depicted semi trailer, four magnified linear generators 1400 could be used, two coupled to each rear axle on opposed sides of the axle on a wheel.

In one aspect, a standard linear generator in line with the suspension in a standard shock configuration for a single axle semi trailer would be roughly 20 inches in diameter by 18 inches high. The available space may not accommodate a generator of this size. A magnified linear generator 1400 that includes a magnification device 1420 to translate input vertical power into a horizontal generator 1410 can accomplish the same dampening as the standard linear generator but with a reduced size of 6 inches in diameter and 48 inches long. The packaging constraints underneath a trailer can allow for longer generators than the available space in line with the suspension of the semi trailer. Additionally, the magnified linear generator 1400 can be designed to account for the dynamics of a semi-trailer. For example, the design can incorporate the energy produced at an average of 65 miles per hour (mph) on a highway as this is where the semi trailer does most of its operating.

### III. Micro-Mobility Applications

A magnified linear generator can be designed specifically for different micro-mobility applications. Some examples of such applications include an electric scooter, an electric bike, a golf cart, and a low powered cycle (e.g. a moped).

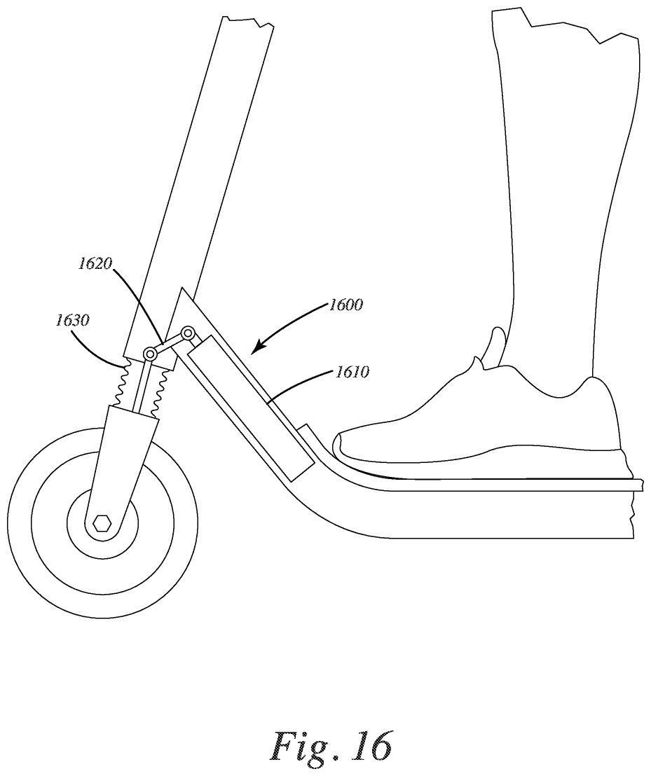

In FIG. 16, a magnified linear generator 1600 is shown incorporated in an electric scooter. As depicted, a magnification device 1620 is a lever and is connected between a shock 1630 of the front wheel of the electric scooter and a linear generator 1610. The magnification device 1620 magnifies the input velocity received from 1630 and translates the force and velocity directionally to be used by linear generator 1610. The output of linear generator 1610 can be converted to DC power and used to charge the battery of the electric scooter to extend the electric scooter's range. In an exemplary design, the magnified linear generator 1600 can account for an average speed of 16 mph and frequent junctions (such as contraction joints) in sidewalk or crosswalks.

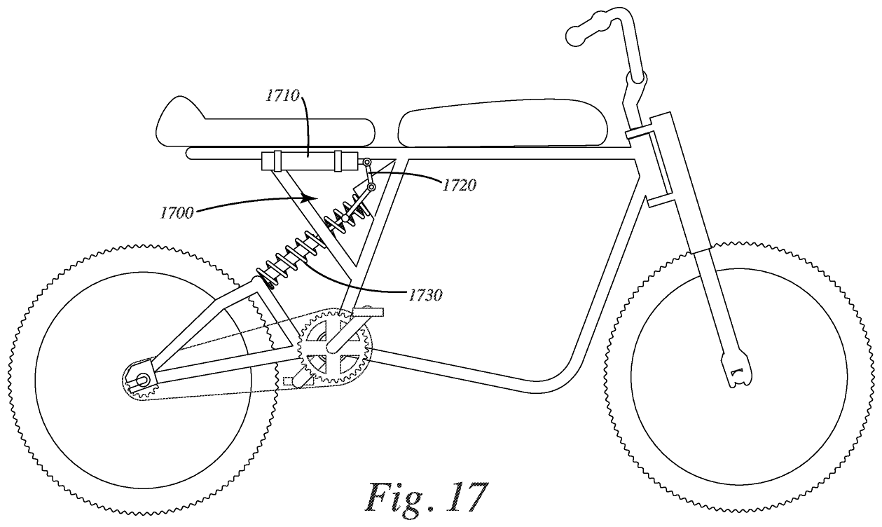

In FIG. 17, a magnified linear generator 1700 is shown incorporated in an electric bike. A magnification device 1720 may be connected between a shock 1730 of the back wheel and a linear generator 1710. As depicted, the magnification device 1720 is a lever and is changing the input motion form 45 degrees to horizontal motion to power the linear generator 1710. In one example, the magnification device 1720 may provide an amplification of the input velocity by a ratio of 7:1. This example magnified linear generator 1700 has a reduced diameter, increased stroke, and increased number of slots transitioned in a cycle. The linear generator 1710 is isolated from the ground vibration because it is fixed to the frame of the electric bike. Put another way, the linear generator 1710 is sprung mass.

In an exemplary magnified linear generator designed for a golf cart, the magnified linear generator may account for an average speed 20 mph and an increased roughness of terrain when compared to roadways.

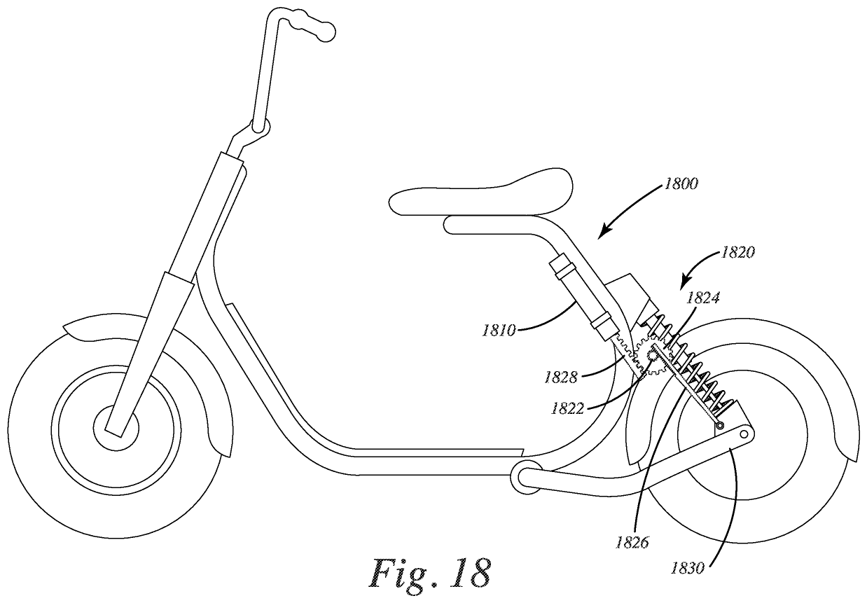

In FIG. 18, a magnified linear generator 1800 is shown incorporated into a low powered cycle. A magnification device 1820 may be connected between a swing arm 1830 of a suspension of the low powered cycle and a linear generator 1810. As depicted, the magnification device 1820 is a one-piece rotary magnification device with a first gear 1822 amplifying horizontal movement through a second gear 1824, where the first gear 1822 has a smaller diameter than the second gear 1824. As the suspension arm 1830 moves up and down from bumps a fixed translator 1826 may spin the first gear 1822 which amplifies linear movement through the second gear 1824 onto a second translator 1828 which is attached to the linear generator 1810. The movement of the second translator 1828 moves a mover of the linear generator 1810. In this aspect, the mover has a magnetic array and the stator has an electric coil array. Thus, the second translator 1828 moves the magnetic array back and forth in the linear generator 1810 creating output power that can be used to charge the low powered cycle and increase its range.

### IV. Shipping Containers

Shipping containers are used to move product on train cars, boats, and also on flatbed semi trailers. In particular, shipping containers that have refrigeration units consume large amounts of electricity to keep the product stored within the refrigeration units at a suitable temperature. Large quantities of power from energy translated from road irregularities (bumps), train track irregularities (bumps), and boat irregularities (wave bumps) is dissipated through the suspension system of a vehicle or dynamic movement. All of this energy is available to be captured by a rotary or linear generator which can turn the mechanical power into electrical power that may be stored, used to power other systems, or a combination of the two.

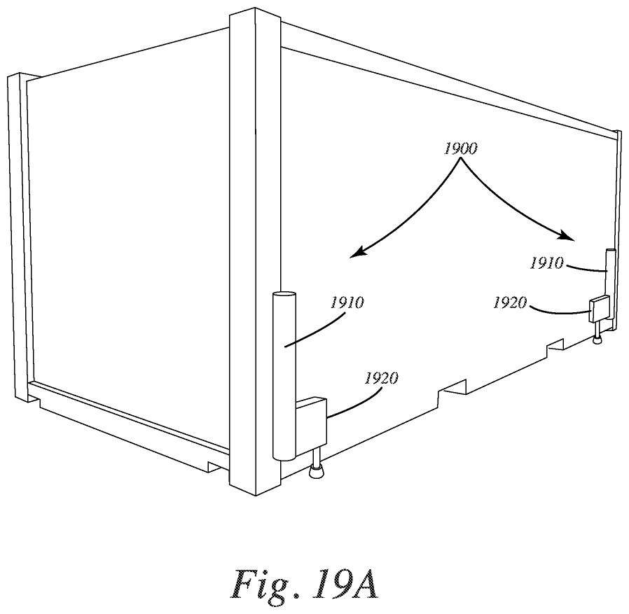

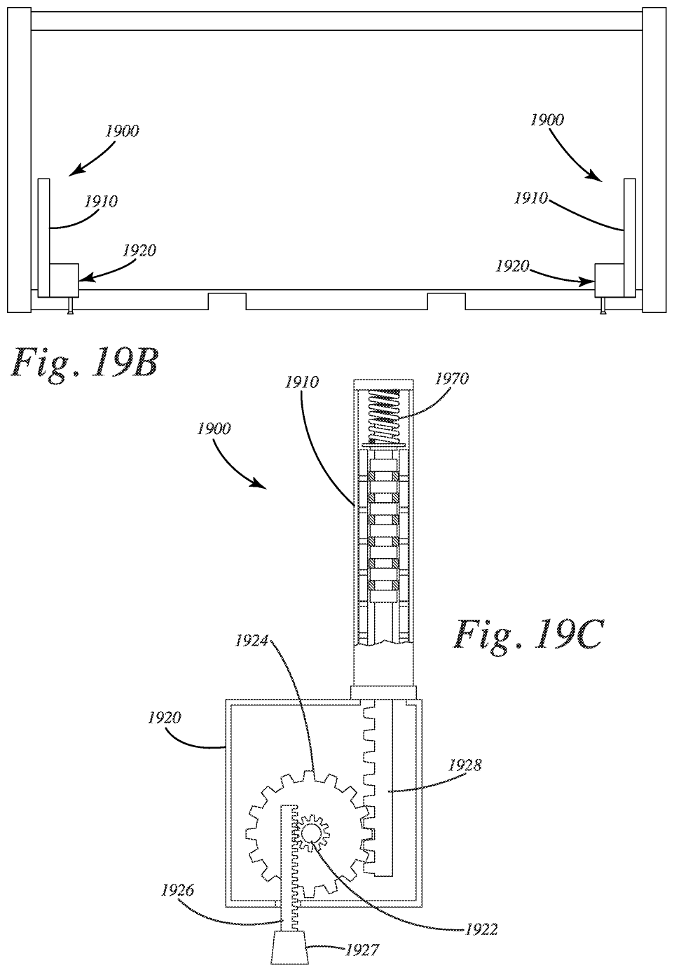

A magnified linear generator may be used to capture a portion of the available energy and send it to a battery, the devices consuming electricity, or a combination of the two. FIGS. 19A-19B show two magnified linear generators 1900 installed on a shipping container. A shipping container may instead utilize one magnified linear generator 1900 or any other number of magnified linear generators 1900 suitable for the application. A front view of one of the magnified linear generators 1900 showing the internal components is depicted in FIG. 19C. Each magnified linear generator 1900 may include a magnification device 1920 and a generator 1910. As depicted in FIGS. 19A-19C, the magnification device 1920 is a rotational magnification device including a first gear 1922 and a second gear 1924, where the first gear 1922 has a smaller diameter than the second gear 1924. In one aspect, rotational magnification device may magnify the input velocity by a ratio of 10:1. A fixed translator 1926 is coupled to a force receiving surface (not shown) and the small gear 1922. In one aspect, the force receiving surface may be a train car and the input power (force, velocity) may be the movement of the train car. The first gear 1922 is coupled to the second gear 1924 which is in turn coupled to a second translator 1928. When the fixed translator 1926 receives a force it rotates the first gear 1922 which in turn rotates the second gear 1924. The rotation of the second gear 1924 causes the second translator 1928 to move, which moves the mover of the linear generator 1910. The movement of the mover causes the linear generator 1910 to output electrical power which may be used to power the devices consuming electricity. As depicted, the linear generator 1910 is positioned vertically with respect to the shipping container. In an alternate aspect, the generator may be oriented in a way that is not vertical and the magnification device may be something other than a rotational magnification device.

In one aspect, the fixed translator 1926 extends beyond the bottom edge of the shipping container and holds the container a set distance above the force receiving surface (e.g. the deck of a ship, the top of the shipping container below this container, not pictured). In one aspect, the set distance is one quarter inch. In an alternate aspect, the set distance may be one half inch, one inch, or any other distance suitable for the application. As depicted, in one aspect, the fixed translator 1926 may be coupled to a stabilizing component 1927 at one end to assist the fixed translator 1927 in supporting the shipping container. The stabilizing component 1927 can be a rubber footing or any other suitable component. In one aspect, a steel plate (not pictured) may be coupled to the force receiving surface (not pictured) to assist the fixed translator 1926 in holding the shipping container a set distance above the force receiving surface. The linear generator 1910 may include a biasing component 1970 (e.g. a coil spring) and a compression plate system (not pictured). As depicted in FIGS. 19A-19B, the linear generator 1910 includes a stator and a mover surrounding the stator, and the biasing component 1970 may be located around the stator to bias the mover to a neutral position in the magnified linear generator 1900. In an alternate aspect, the biasing component 1970 can be located anywhere in the magnified linear generator 1900 and it can be a cone spring, leaf spring, a torsion system, or any other suitable biasing component.

The compression plate system may apply pressure to the biasing component 1970 thus biasing the mover of the linear generator 1910 to a mid-point of the linear generator 1910. This compression force can in turn be translated through magnification device 1920 to the fixed translator 1926, thereby biasing the fixed translator 1926 outward and holding the shipping container the set distance above the force receiving surface. When the fixed translator 1926 receives an input power (force, velocity) from the force receiving surface, the magnification device 1920 can magnify the input velocity and pass the magnified velocity to the linear generator 1910. In the depicted embodiment of FIGS. 19A-19B, the mover of the linear generator 1910 may move upward until the magnified velocity and output force are overcome by the force of the biasing component 1970 and the magnified linear generator 1900 can return back to its neutral position. The movement of the mover of the linear generator 1910 is the power stroke of the magnified linear generator 1900.

The magnified linear generator 1900 may be tuned such that the force to move the mover one stroke is less than the input force generated from surface irregularities after being reduced by magnification device 1920. The amount of output force to move the mover one stroke may vary depending on the vehicle currently housing the shipping container for transportation. For example, on a rail car the unsprung (e.g. train car) mass is so high that the magnified velocity is 10 to 20 times more than it would be on a semi trailer. In one aspect, the magnified linear generator 1900 may be designed for one mode of transportation and the magnification factor of magnification device 1920 and the biasing force of the biasing component 1970 may be set accordingly. However, in many applications, a given shipping container may use many forms of transit (e.g. a semi trailer, train, and boat or any combination thereof) during a single trip. Thus, in one aspect, the compression system (not shown) may adjust the biasing force of the biasing component 1970 through software. In one aspect, the magnified linear generator 1910 may generate a sufficient amount of power to run a refrigerated container when positioned on a train traveling 45 mph down the rail. In one aspect, the magnified linear generator 1900 may output power to an electrical power receptacle (not pictured) through wires in the rails of the shipping container.

In one example, with reference to FIG. 11, when the refrigerated shipping container is installed on a flatbed semi trailer travelling on a near smooth surface (AUN=1 cm³), the immense unsprung weight and the interaction of the weight of the semi trailer may generate roughly 10 kWh/100 km (166 Wh per mile) with two magnified linear generators 1900 installed. A typical refrigerated container consumes less than 100 Wh per mile. Thus, this system could be used to power the refrigerated container instead of a diesel or gas generator or a large battery back. This can increase the amount of goods able to be transported in refrigerated shipping containers.

### V. Hydraulic Magnification

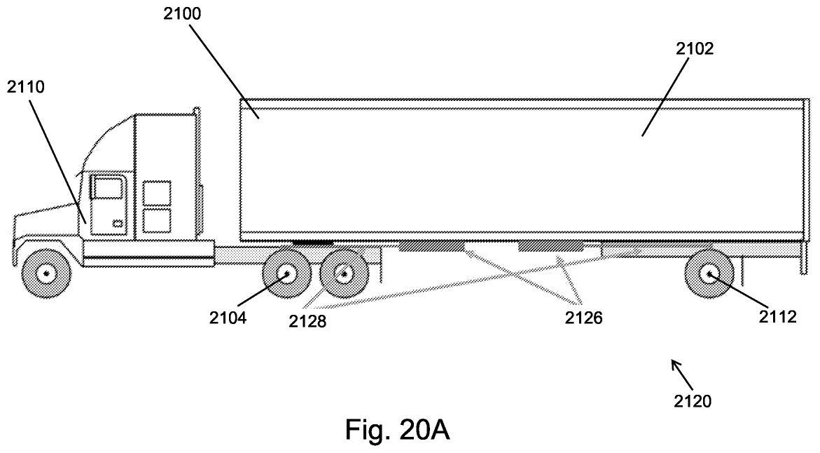

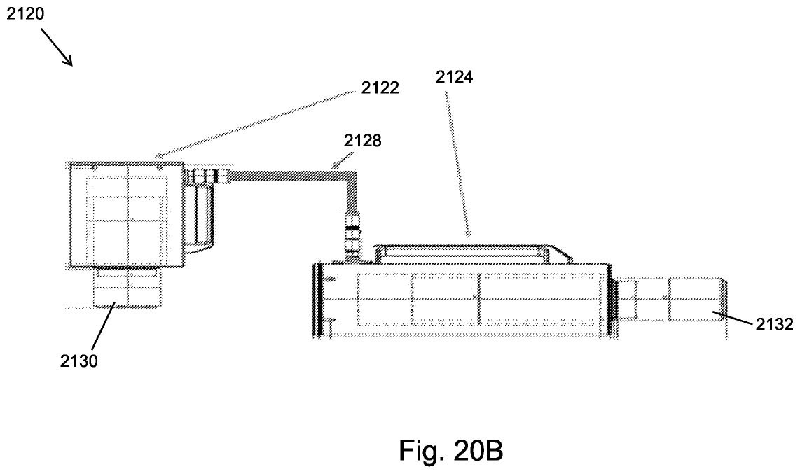

In another embodiment, the magnified suspension stroke for power production of a generator (linear or rotary) may be provided via a hydraulic system 2120, which may facilitate better utilization of space within a vehicle 2100. Referring to FIGS. 20A, 20B and 20C, several implementations are available including using a larger diameter cylinder 2122 on a suspension and connecting that cylinder 2122 to a smaller diameter cylinder 2124 to amplify the stroke of the suspension. Other implementations involve using a reservoir in between the two cylinders. Additional other traditional fluid dynamic systems can be used to accomplish the implementation. One of the implementations that is of most interest is mounting generators 2126 on a semi-trailer 2102 and then tying in cylinders on the suspension of the semi rig axles 2104 back to the generators 2126 on the trailer 2102. A semi rig in general does not have the space to accommodate the large generators 2126 but they can accommodate a hydraulic cylinder 2122 that connects back to the generator 2126 on the trailer 2102. As shown in FIG. 1, one implementation could be attaching hydraulic cylinders (such as cylinder 2122) to each axle 2104 on the semi rig 2110 (Tractor), two cylinders 2122 on each axle 2104, and then attaching those cylinders 2122 via hydraulic lines 2128 back to generators 2126 located on the trailer 2102. FIG. 20A also shows hydraulic cylinders 2122 on the rear axle 2112 of the semi-trailer 2102 connected by hydraulic lines 2128 to generators 2126 mounted under the trailer 2102. FIG. 20B shows a larger diameter cylinder 2122 which would be attached to either or both the semi rig (tractor) axles 2104 as well as the axles 2112 on the semi-trailer 2102. These cylinders 2122 are attached by hydraulic lines 2128 to a smaller diameter cylinder 2124 which moves the generator 2126. This acts as a stroke amplifier; an example would be taking a 1 inch stroke on the suspension and turning it into a 3 inch stroke in the generator 2126. In one embodiment, the larger diameter cylinder 2122 includes a movable mount portion 2130 that may be connected to the axle 2104, 2112 in a manner such that the movable mount portion 2130 moves with the ground engaging surface. The smaller diameter cylinder 2124 includes a movable mount portion 2132 connected to the generator 2126.

Using such a system with hydraulic amplification is just a continuation of a mechanical advantage using cylinders instead of gears/levers or other such mechanisms and can be implemented on any vehicle system.

The ability to collect, transmit and analyze road data on available energy based on vehicle speed, weight, tire pressure and spring rate can be used to predict available energy for other vehicles using the roadways at a later date.

This system of power generation from road energy is intended to be used to either power an electric vehicle directly, charge a battery system or be used for power other electrical systems. An initial implementation is a hybrid semi-trailer where generators provide power to a battery pack which in turn runs a refrigerated unit on the trailer. Power can be captured from just the trailer, the semi rig or a both the trailer and rig. The system can be incorporated with an electric motor driving the rear axle of the semi-trailer and used to improve fuel economy of a semi rig (tractor) when internal combustion engine powered or increase range when electric powered.

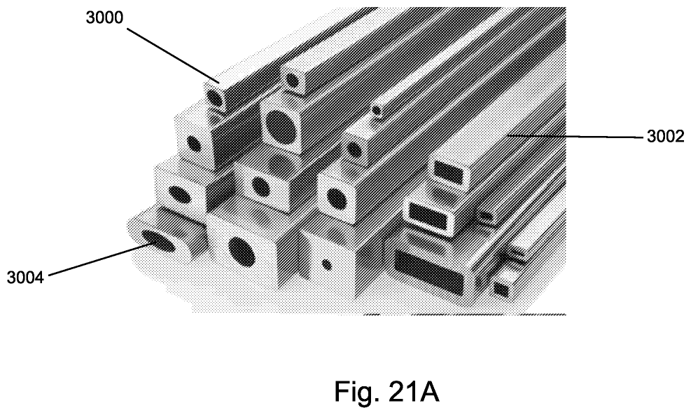

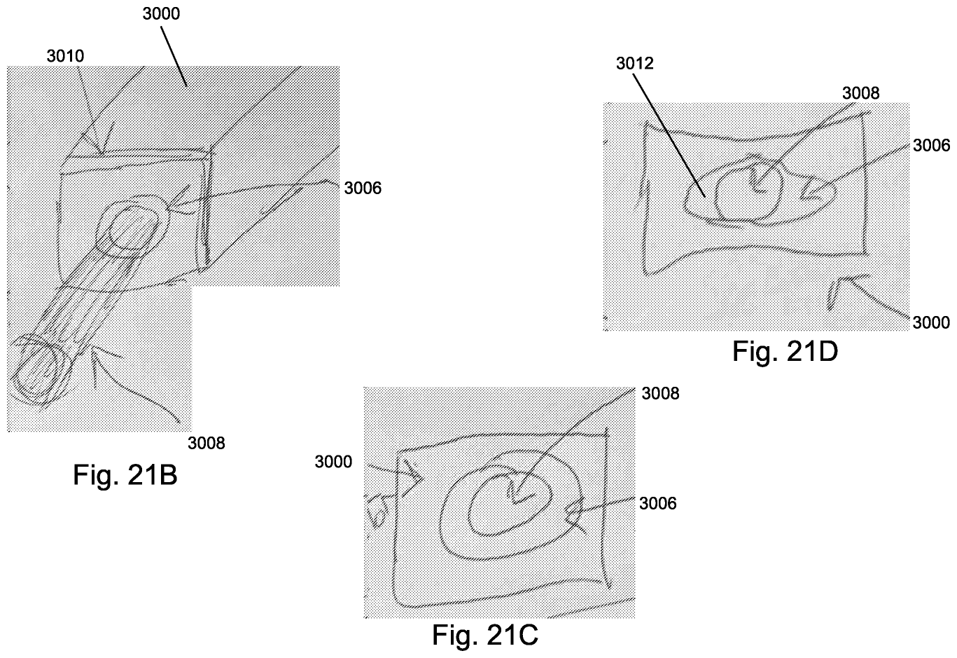

In another embodiment, the present invention may utilize one or more hollow conductors within a linear or rotary generator system. With reference to FIGS. 21A-21D, a hollow conductor 3000 is shown, which may be formed from copper or another conductive material. FIG. 21A shows a plurality of differently shaped hollow conductors 3000, each with an outer surface 3002, and a hollow interior opening 3004. These hollow conductors 3000 may be used in a variety of applications within the present invention, including as internal coils within the generator or as external electrical connectors. In one embodiment, shown in FIGS. 21B-21D, the hollow conductors 3000 may be filled with a fill material 3006 that allows electricity to be transmitted more efficiently, and this improve the generator performance. In one example, the fill material 3006 is graphene, and the graphene is used to fill the inside of a copper conductor. Hollow copper conductors 3000 are readily available, but the use of a graphene fill material 3006 in the hollow void 3004 may improve the performance of the conductor 3000. The hollow conductors 3000, which are primarily formed by an extrusion process, by nature are limited on the size of the internal opening 3004. Typically, the amount of graphene fill material 3006 needed to transmit power is minimal compared to the industry's ability to make the internal hole 3004 smaller. In the embodiment shown in FIGS. 21B-D, an uncoated conductor wire 3008, with a diameter smaller than the conductor opening 3004, is inserted through the opening 3004, and the graphene fill material 3006 is inserted within the opening 3004 around the conductor wire 3008 to fill the gap between the conductor wire 3008 and the opening 3004. This can enable the use of a smaller amount of graphene within the opening 3004, as graphene can be cost prohibitive. In one example, a 5 mm rectangle hollow conductor 3000 with a 3 mm round hole 3004 through it may include a solid 2 mm round conductor wire 3008 inserted and then the graphene fill material 3006 is filled in around the wire 3008. In this case the graphene may be loose, but the loose graphene may still contact the loose graphene around it with enough connections to transmit power. The wire conductor 3008 may extends beyond the end plate 3010, which are soldered to the ends of the hollow conductor 3000, and seal off the graphene fill material 3006 to preventing it from escaping.

With reference to FIG. 21D, one benefit of using a solid conductor wire 3008 with graphene fill material 3006 filled around the wire 3008 is that when the hollow, filled conductor 3000 is bent around the magnetic material in the generator/motor, the solid conductor wire 3008 maintains the hollow conductor center void 3004 from collapsing and forms the general shape of an eye with the wire 3008 in the center and two pockets 3012 on each side filled with loose graphene 3006.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Features of various embodiments may be used in combination with features from other embodiments. Directional terms, such as “vertical,” “horizontal,” “top,” “bottom,” “front,” “rear,” “upper,” “lower,” “inner,” “inwardly,” “outer,” “outwardly,” “forward,” and “rearward” are used to assist in describing the invention based on the orientation of the embodiments shown in the illustrations. The use of directional terms should not be interpreted to limit the invention to any specific orientation(s). Any reference to claim elements in the singular, for example, using the articles “a,” “an,” “the,” or “said,” is not to be construed as limiting the element to the singular.

The embodiments of the invention in which an exclusive property or privilege is claimed are defined as follows:

1. A magnified power generation system for use with a vehicle, the system comprising:
a power generator including:
a stator; and
a mover; and
a mechanical magnification component coupled to the mover and coupled to a force receiving surface of the vehicle, wherein the mechanical magnification component receives an input power from the force receiving surface, wherein the input power includes an input force and an input velocity, wherein the mechanical magnification component magnifies the input velocity to become a magnified velocity, wherein the mechanical magnification component transfers the magnified velocity to the power generator and wherein the power generator translates the magnified velocity into electrical energy, the mechanical magnification component including a first hydraulic cylinder coupled to the force receiving surface and a second hydraulic cylinder connected to the mover, the first hydraulic cylinder having a first cylinder diameter, the second hydraulic cylinder having a second cylinder diameter smaller than the first cylinder diameter, wherein the first hydraulic cylinder is connected to the second hydraulic cylinder by a hydraulic line, wherein the hydraulic cylinders operate to magnify the input velocity.

2. The system of claim 1, wherein the vehicle includes a tow vehicle and trailer, the first hydraulic cylinder mounted to the tow vehicle, the second hydraulic cylinder mounted to the trailer, and the hydraulic line extending between the tow vehicle and the trailer.

3. The system of claim 2, wherein the force receiving surface on the tow vehicle is an axle, and wherein the first hydraulic cylinder is mounted to the axle.

4. The system of claim 3, wherein the stator is mounted to the trailer.

5. The system of claim 5 wherein the trailer includes a refrigeration system, the power generator being electrically connected to the refrigeration system to provide power to the refrigeration system.

6. The system of claim 5 wherein the trailer includes an axle, and wherein a third hydraulic cylinder is mounted to the trailer axle, the third hydraulic cylinder connected to the mover.

7. The system of claim 1, wherein the mover and stator are mounted to the semi-trailer with the mover extending in a second direction and the mechanical magnification component translates the input force from a first direction to the second direction as it also magnifies the input velocity to the magnified velocity.

8. The system of claim 1, wherein the stator includes a plurality of electrical windings to generate a three-phase electrical power, and wherein the mover includes a plurality of magnets spaced apart with a soft magnetic composite material between each pair of the plurality of magnets.

9. The system of claim 8, wherein the mover at least partially surrounds the stator.

10. The system of claim 1, wherein the power generator is at least one of a linear generator and a rotary generator.

11. The system of claim 1, comprising: a biasing component coupled to the mover, wherein the biasing component assists in coupling the mover and the stator together, and wherein the biasing component applies a biasing force to the mover to bias the mover to a neutral position in the system.

12. The system of claim 11, wherein the biasing component comprises: a compressible material coupled to the mover; and a motor coupled to the compressible material, the motor configured to vary the compression of the compressible material.

13. A magnified linear power generation system for use with a vehicle, the system comprising: a linear power generator including: a stator including a plurality of electrical coils, a plurality of stator cups, and a fixed shaft, wherein the coils are bobbin-wound coils and each coil is wound around one of the plurality of stator cups, wherein the stator cups are positioned along the fixed shaft; a mover including a plurality of magnets and a material between each of the plurality of magnets separating each magnet from the next magnet by a fixed distance, wherein the mover at least partially surrounds the stator; and a housing surrounding the mover and the stator, the housing having a non-magnetic outer surface; a casing, the casing surrounding the linear power generator; and a mechanical magnification component coupled to the mover at a first end and coupled to a force receiving surface of the vehicle at a second end, wherein the mechanical magnification component receives an input mechanical power from the force receiving surface, wherein the input mechanical power includes an input mechanical force and an input mechanical velocity, wherein the mechanical magnification component magnifies the input mechanical velocity to become a magnified mechanical velocity, wherein the mechanical magnification component transfers the magnified mechanical velocity to the mover, and wherein the mover moves along the stator thereby translating the magnified mechanical velocity into electrical energy, wherein the mechanical magnification component includes a first hydraulic cylinder coupled to the force receiving surface and a second hydraulic cylinder connected to the mover, the first hydraulic cylinder having a first cylinder diameter, the second hydraulic cylinder having a second cylinder diameter smaller than the first cylinder diameter, wherein the first hydraulic cylinder is connected to the second hydraulic cylinder by a hydraulic line, wherein the hydraulic cylinders operate to magnify the input velocity.

14. The system of claim 13, wherein the input force is provided in a first direction and wherein the mover moves in a second direction different from the first direction and wherein the mechanical magnification component changes the direction of the force from the first direction to the second direction.

15. The system of claim 13, wherein the vehicle includes a tow vehicle and trailer, the first hydraulic cylinder mounted to the tow vehicle, the second hydraulic cylinder mounted to the trailer, and the hydraulic line extending between the tow vehicle and the trailer.

16. The system of claim 15, wherein the force receiving surface on the tow vehicle is an axle, and wherein the first hydraulic cylinder is mounted to the axle.

17. The system of claim 16, wherein the stator is mounted to the trailer.

18. The system of claim 17, wherein the trailer includes a refrigeration system, the linear power generator being electrically connected to the refrigeration system to provide power to the refrigeration system.

19. The system of claim 18, wherein the trailer includes an axle, and wherein a third hydraulic cylinder is mounted to the trailer axle, the third hydraulic cylinder connected to the mover.

20. A magnified power generation system comprising:
a vehicle including a tow vehicle and a trailer, the trailer being separable from the tow vehicle, the vehicle including at least one force receiving surface, the force receiving surface receiving input forces from the ground as the vehicle moves across the ground;
a power generator including a stator and a mover, the power generator mounted to the trailer; and
a mechanical magnification component coupled between the power generator and the force receiving surface of the vehicle, the mechanical magnification component including a first hydraulic cylinder connected to the force receiving surface and a second hydraulic cylinder connected to the power generator, the first hydraulic cylinder having a first cylinder diameter, the second hydraulic cylinder having a second cylinder diameter smaller than the first cylinder diameter, wherein the first hydraulic cylinder is connected to the second hydraulic cylinder by a hydraulic line extending between the tow vehicle and the trailer.
